(19) United States
(12) Patent Application Publication
(10) Pub. No.: US 2025/0124601 A1
(43) Pub. Date: Apr. 17, 2025

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Hanje PARK, Seoul (KR); Donggyu SIM, Seoul (KR); Joohyung BYEON, Seoul (KR)

(21) Appl. No.: 18/728,694

(22) PCT Filed: Jan. 13, 2023
(86) PCT No.: PCT/KR2023/000645

§ 371 Date: Jul. 12, 2024

(30) Foreign Application Priority Data
Jan. 13, 2022 (KR) 10-2022-0005246

(51) Int. Cl. G06T 9/00; H04N 19/597

(52) U.S. Cl. CPC G06T 9/00; H04N 19/597

(57) ABSTRACT

A point cloud data transmission method according to embodiments may comprise the steps of: encoding point cloud data; and transmitting a bitstream including the point cloud data. A point cloud data reception method according to embodiments may comprise the steps of: receiving the bitstream including the point cloud data; and decoding the point cloud data.

### TECHNICAL FIELD

Embodiments provide a method for providing point cloud content to provide a user with various services such as virtual reality (VR), augmented reality (AR), mixed reality (MR), and self-driving services.

### BACKGROUND ART

A point cloud is a set of points in a three-dimensional (3D) space. It is difficult to generate point cloud data because the number of points in the 3D space is large.

A large throughput is required to transmit and receive data of a point cloud.

### DISCLOSURE

### Technical Problem

An object of the present disclosure is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

### Technical Solution

A point cloud data transmission method according to embodiments may comprise the steps of: encoding point cloud data; and transmitting the point cloud data. A point cloud data reception method according to embodiments may comprise the steps of: receiving point cloud data; and decoding the point cloud data.

### Advantageous Effects

The point cloud data transmission method, the point cloud data transmission apparatus, the point cloud data reception method, and the point cloud data reception apparatus according to the embodiments may provide a good-quality point cloud service.

The point cloud data transmission method, the point cloud data transmission apparatus, the point cloud data reception method, and the point cloud data reception apparatus according to the embodiments may achieve various video codec methods.

The point cloud data transmission method, the point cloud data transmission apparatus, the point cloud data reception method, and the point cloud data reception apparatus according to the embodiments may provide universal point cloud content such as a self-driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of the minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to embodiments;

FIG. 20 illustrates an exemplary structure operable in connection with point cloud data transmission/reception methods/devices according to embodiments;

FIG. 21 illustrates encoding and decoding based on connection information in encoding and/or decoding an occupancy map according to embodiments;

FIG. 22 illustrates a mesh data encoder having a texture map as color information according to embodiments;

FIG. 23 illustrates a mesh data encoder having a color per vertex as color information according to embodiments;

FIG. 24 illustrates a connection information encoder according to embodiments;

FIG. 25 illustrates a texture map encoder according to embodiments;

FIG. 27 illustrates a vertex texture coordinate encoder according to embodiments;

FIG. 28 illustrates a normal information encoder according to embodiments;

FIG. 29 illustrates a normal information encoder according to embodiments;

FIG. 30 illustrates auxiliary information, depth image, and occupancy map coordinate encoders according to embodiments;

FIG. 31 illustrates an example of depth image down-sampling (encoder) and up-sampling (decoder) according to embodiments;

FIG. 32 illustrates an occupancy map coordinate information encoder according to embodiments;

FIG. 33 illustrates a mesh data decoder having a texture map as color information according to embodiments;

FIG. 34 illustrates a mesh data decoder having a color per vertex as color information according to embodiments;

FIG. 35 illustrates a connection information decoder according to embodiments;

FIG. 36 illustrates a normal information decoder according to embodiments;

FIG. 37 illustrates a normal information decoder according to embodiments;

FIG. 38 illustrates a texture coordinate decoder according to embodiments;

FIG. 39 illustrates a texture coordinate decoder according to embodiments;

FIG. 40 illustrates an auxiliary information decoder and a position information decoder according to embodiments;

FIG. 41 illustrates an occupancy map coordinate decoder according to embodiments;

FIG. 42 illustrates a patch index map and coordinates of a 2D bounding box of a patch according to embodiments;

FIG. 42 illustrates a patch index map and coordinates of a 2D bounding box of a patch according to embodiments;

FIG. 43 illustrates an example of depth image up-sampling according to embodiments;

FIG. 44 illustrates a bitstream according to embodiments;

FIG. 45 illustrates decode position information according to embodiments;

FIGS. 46 and 47 illustrate decode position and decode patch index occupancy map coordinates according to embodiments;

FIG. 48 illustrates a method of transmitting point cloud data according to embodiments; and

FIG. 49 illustrates a method of receiving point cloud data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

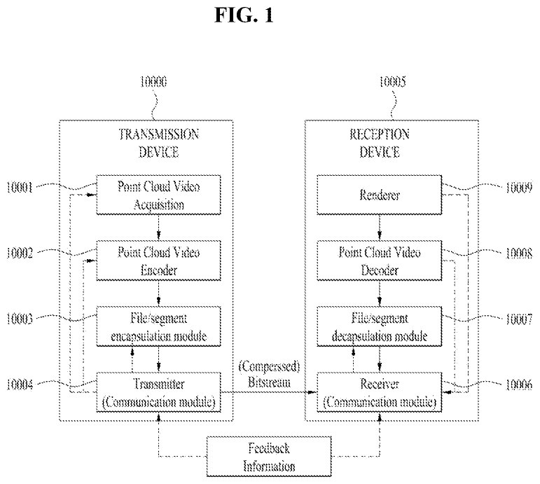

FIG. 1 illustrates an exemplary structure of a transmission/reception system for providing point cloud content according to embodiments.

The present disclosure provides a method of providing point cloud content to provide a user with various services such as virtual reality (VR), augmented reality (AR), mixed reality (MR), and self-driving. The point cloud content according to the embodiments represent data representing objects as points, and may be referred to as a point cloud, point cloud data, point cloud video data, point cloud image data, or the like.

A point cloud data transmission device 10000 according to embodiment may include a point cloud video acquirer 10001, a point cloud video encoder 10002, a file/segment encapsulation module 10003, and/or a transmitter (or communication module) 10004. The transmission device according to the embodiments may secure and process point cloud video (or point cloud content) and transmit the same. According to embodiments, the transmission device may include a fixed station, a base transceiver system (BTS), a network, an artificial intelligence (AI) device and/or system, a robot, and an AR/VR/XR device and/or a server. According to embodiments, the transmission device 10000 may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The point cloud video acquirer 10001 according to the embodiments acquires a point cloud video through a process of capturing, synthesizing, or generating a point cloud video.

The point cloud video encoder 10002 according to the embodiments encodes the point cloud video data. According to embodiments, the point cloud video encoder 10002 may be referred to as a point cloud encoder, a point cloud data encoder, an encoder, or the like. The point cloud compression coding (encoding) according to the embodiments is not limited to the above-described embodiment. The point cloud video encoder may output a bitstream containing the encoded point cloud video data. The bitstream may not only include encoded point cloud video data, but also include signaling information related to encoding of the point cloud video data.

The encoder according to the embodiments may support both the geometry-based point cloud compression (G-PCC) encoding scheme and/or the video-based point cloud compression (V-PCC) encoding scheme. In addition, the encoder may encode a point cloud (referring to either point cloud data or points) and/or signaling data related to the point cloud. The specific operation of encoding according to embodiments will be described below.

As used herein, the term V-PCC may stand for Video-based Point Cloud Compression (V-PCC). The term V-PCC may be the same as Visual Volumetric Video-based Coding (V3C). These terms may be complementarily used.

The file/segment encapsulation module 10003 according to the embodiments encapsulates the point cloud data in the form of a file and/or segment form. The point cloud data transmission method/device according to the embodiments may transmit the point cloud data in a file and/or segment form.

The transmitter (or communication module) 10004 according to the embodiments transmits the encoded point cloud video data in the form of a bitstream. According to embodiments, the file or segment may be transmitted to a reception device over a network, or stored in a digital storage medium (e.g., USB, SD, CD, DVD, Blu-ray, HDD, SSD, etc.). The transmitter according to the embodiments is capable of wired/wireless communication with the reception device (or the receiver) over a network of 4G, 5G, 6G, etc. In addition, the transmitter may perform necessary data processing operation according to the network system (e.g., a 4G, 5G or 6G communication network system). The transmission device may transmit the encapsulated data in an on-demand manner.

A point cloud data reception device 10005 according to the embodiments may include a receiver 10006, a file/segment decapsulation module 10007, a point cloud video decoder 10008, and/or a renderer 10009. According to embodiments, the reception device may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data. The decapsulation module according to the embodiments may perform a reverse process of the encapsulation process according to the embodiments.

The point cloud video decoder 10007 decodes the received point cloud video data. The decoder according to the embodiments may perform a reverse process of encoding according to the embodiments.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver. According to embodiments, the feedback information received by the point cloud transmission device may be provided to the point cloud video encoder.

The arrows indicated by dotted lines in the drawing represent a transmission path of feedback information acquired by the reception device 10005. The feedback information is information for reflecting interactivity with a user who consumes point cloud content, and includes user information (e.g., head orientation information), viewport information, and the like). In particular, when the point cloud content is content for a service (e.g., self-driving service, etc.) that requires interaction with a user, the feedback information may be provided to the content transmitting side (e.g., the transmission device 10000) and/or the service provider. According to embodiments, the feedback information may be used in the reception device 10005 as well as the transmission device 10000, and may not be provided.

The head orientation information according to embodiments is information about a user's head position, orientation, angle, motion, and the like. The reception device 10005 according to the embodiments may calculate viewport information based on the head orientation information. The viewport information may be information about a region of the point cloud video that the user is viewing. A viewpoint is a point where a user is viewing a point cloud video, and may refer to a center point of the viewport region. That is, the viewport is a region centered on the viewpoint, and the size and shape of the region may be determined by a field of view (FOV). Accordingly, the reception device 10005 may extract the viewport information based on a vertical or horizontal FOV supported by the device in addition to the head orientation information. In addition, the reception device 10005 performs gaze analysis to check how the user consumes a point cloud, a region that the user gazes at in the point cloud video, a gaze time, and the like. According to embodiments, the reception device 10005 may transmit feedback information including the result of the gaze analysis to the transmission device 10000. The feedback information according to the embodiments may be acquired in the rendering and/or display process. The feedback information according to the embodiments may be secured by one or more sensors included in the reception device 10005. In addition, according to embodiments, the feedback information may be secured by the renderer 10009 or a separate external element (or device, component, etc.). The dotted lines in FIG. 1 represent a process of transmitting the feedback information secured by the renderer 10009. The point cloud content providing system may process (encode/decode) point cloud data based on the feedback information. Accordingly, the point cloud video data decoder 10008 may perform a decoding operation based on the feedback information. The reception device 10005 may transmit the feedback information to the transmission device. The transmission device (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) all point cloud data, and provide point cloud content to the user.

According to embodiments, the transmission device 10000 may be called an encoder, a transmission device, a transmitter, or the like, and the reception device 10004 may be called a decoder, a reception device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to point cloud data.

The elements of the point cloud content providing system illustrated in FIG. 1 may be implemented by hardware, software, a processor, and/or combinations thereof.

Embodiments may provide a method of providing point cloud content to provide a user with various services such as virtual reality (VR), augmented reality (AR), mixed reality (MR), and self-driving.

In order to provide a point cloud content service, a point cloud video may be acquired first. The acquired point cloud video may be transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a geometry-based point cloud compression process.

Each element of the point cloud data transmission device and the point cloud data reception device according to the embodiments may be hardware, software, a processor, and/or a combination thereof.

In order to provide a point cloud content service, a point cloud video may be acquired. The acquired point cloud video is transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service may include an acquisition process, an encoding process, a transmission process, a decoding process, a rendering process, and/or a feedback process.

The point cloud compression system may include a transmission device and a reception device. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device may include a point cloud video acquirer, a point cloud video encoder, a file/segment encapsulator, and a transmitter. The reception device may include a receiver, a file/segment decapsulator, a point cloud video decoder, and a renderer. The encoder may be referred to as a point cloud video/picture/picture/frame encoder, and the decoder may be referred to as a point cloud video/picture/picture/frame decoding device. The transmitter may be included in the point cloud video encoder. The receiver may be included in the point cloud video decoder. The renderer may include a display. The renderer and/or the display may be configured as separate devices or external components. The transmission device and the reception device may further include a separate internal or external module/unit/component for the feedback process.

According to embodiments, the operation of the reception device may be the reverse process of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the Stanford Triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data. The data may be transmitted in the form of a bitstream containing a point cloud.

A point cloud data reception device according to embodiments may include a receiver configured to receive point cloud data, a decoder configured to decode the point cloud data, and a renderer configured to render the point cloud data.

The method/device according to the embodiments represents the point cloud data transmission device and/or the point cloud data reception device.

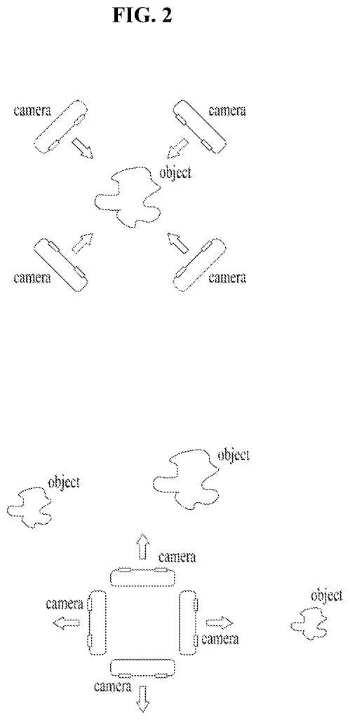

FIG. 2 illustrates capture of point cloud data according to embodiments.

Point cloud data according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example, according to embodiments, there may be four cameras.

The point cloud data or the point cloud content according to the embodiments may be a video or a still image of an object/environment represented in various types of 3D spaces. According to embodiments, the point cloud content may include video/audio/an image of an object.

For capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as self-driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder may encode the input point cloud video into one or more video streams. One video may include a plurality of frames, each of which may correspond to a still image/picture. In this specification, a point cloud video may include a point cloud image/frame/picture/video/audio. In addition, the term “point cloud video” may be used interchangeably with a point cloud image/frame/picture. The point cloud video encoder may perform a video-based point cloud compression (V-PCC) procedure. The point cloud video encoder may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder may encode point cloud video by dividing the same into a geometry video, an attribute video, an occupancy map video, and auxiliary information, which will be described later. The geometry video may include a geometry image, the attribute video may include an attribute image, and the occupancy map video may include an occupancy map image. The auxiliary information may include auxiliary patch information. The attribute video/image may include a texture video/image.

The encapsulation processor (file/segment encapsulation module) 1003 may encapsulate the encoded point cloud video data and/or metadata related to the point cloud video in the form of, for example, a file. Here, the metadata related to the point cloud video may be received from the metadata processor. The metadata processor may be included in the point cloud video encoder or may be configured as a separate component/module. The encapsulation processor may encapsulate the data in a file format such as ISOBMFF or process the same in the form of a DASH segment or the like. According to an embodiment, the encapsulation processor may include the point cloud video-related metadata in the file format. The point cloud video metadata may be included, for example, in boxes at various levels on the ISOBMFF file format or as data in a separate track within the file. According to an embodiment, the encapsulation processor may encapsulate the point cloud video-related metadata into a file. The transmission processor may perform processing for transmission on the point cloud video data encapsulated according to the file format. The transmission processor may be included in the transmitter or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor along with the point cloud video data, and perform processing of the point cloud video data for transmission.

The transmitter 1004 may transmit the encoded video/image information or data that is output in the form of a bitstream to the receiver of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 1003 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver or may be configured as a separate component/module. The reception processor may reversely perform the above-described process of the transmission processor such that the processing corresponds to the processing for transmission performed at the transmission side. The reception processor may deliver the acquired point cloud video data to the decapsulation processor, and the acquired point cloud video-related metadata to the metadata parser. The point cloud video-related metadata acquired by the reception processor may take the form of a signaling table.

The decapsulation processor (file/segment decapsulation module) 10007 may decapsulate the point cloud video data received in the form of a file from the reception processor. The decapsulation processor may decapsulate the files according to ISOBMFF or the like, and may acquire a point cloud video bitstream or point cloud video-related metadata (a metadata bitstream). The acquired point cloud video bitstream may be delivered to the point cloud video decoder, and the acquired point cloud video-related metadata (metadata bitstream) may be delivered to the metadata processor. The point cloud video bitstream may include the metadata (metadata bitstream). The metadata processor may be included in the point cloud video decoder or may be configured as a separate component/module. The point cloud video-related metadata acquired by the decapsulation processor may take the form of a box or a track in the file format. The decapsulation processor may receive metadata necessary for decapsulation from the metadata processor, when necessary. The point cloud video-related metadata may be delivered to the point cloud video decoder and used in a point cloud video decoding procedure, or may be transferred to the renderer and used in a point cloud video rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer may render the reconstructed geometry and the color point cloud image/picture. The rendered video/image may be displayed through the display. The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/self-driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value. It may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area in some cases. In a general case, an M×N block may include samples (or a sample array) or a set (or array) of transform coefficients configured in M columns and N rows.

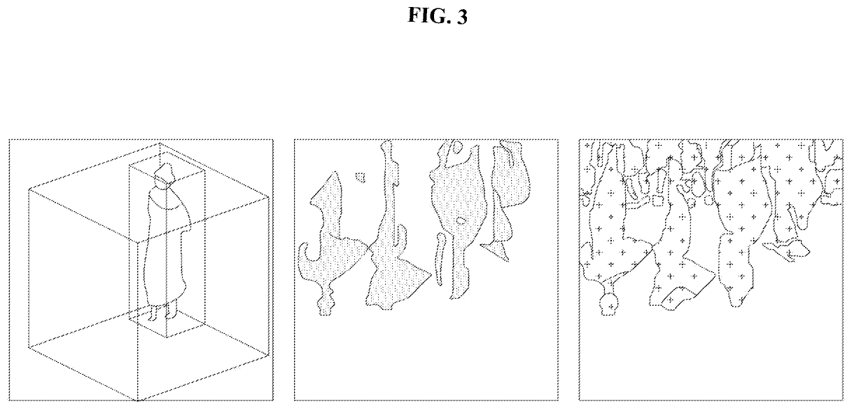

FIG. 3 illustrates an example of a point cloud, a geometry image, and a texture image according to embodiments.

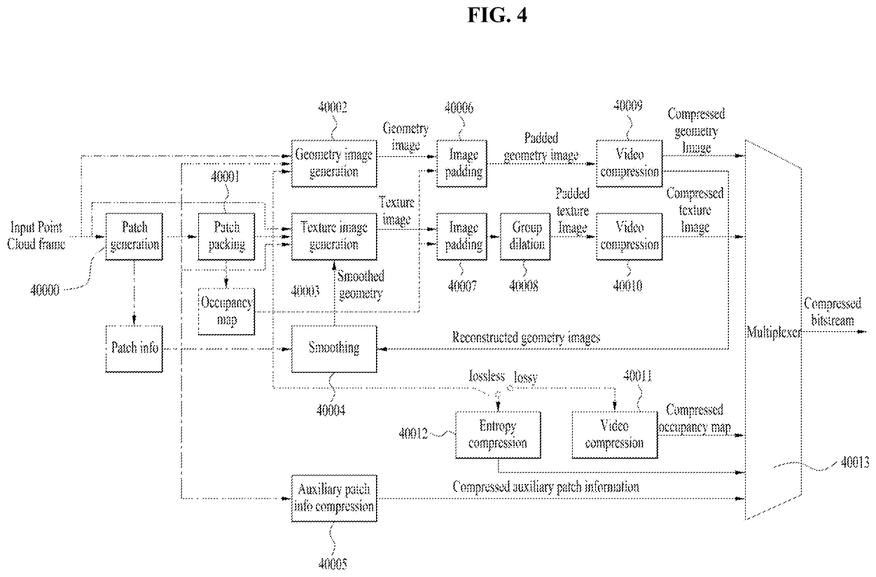

A point cloud according to the embodiments may be input to the V-PCC encoding process of FIG. 4, which will be described later, to generate a geometric image and a texture image. According to embodiments, a point cloud may have the same meaning as point cloud data.

As shown in the figure, the left part shows a point cloud, in which an object is positioned in a 3D space and may be represented by a bounding box or the like. The middle part shows the geometry, and the right part shows a texture image (non-padded image).

Video-based point cloud compression (V-PCC) according to embodiments may provide a method of compressing 3D point cloud data based on a 2D video codec such as HEVC or VVC. Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane. The occupancy map may represent a 2D array corresponding to ATLAS, and the values of the occupancy map may indicate whether each sample position in the atlas corresponds to a 3D point.

An atlas is a collection of 2D bounding boxes positioned in a rectangular frame that correspond to a 3D bounding box in a 3D space in which volumetric data is rendered and information related thereto.

The atlas bitstream is a bitstream for one or more atlas frames constituting an atlas and related data.

The atlas frame is a 2D rectangular array of atlas samples onto which patches are projected.

An atlas sample is a position of a rectangular frame onto which patches associated with the atlas are projected.

An atlas frame may be partitioned into tiles. A tile is a unit in which a 2D frame is partitioned. That is, a tile is a unit for partitioning signaling information of point cloud data called an atlas.

Patch: A set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel. Geometry represents a set of coordinates associated with a point cloud frame.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info: this indicates metadata needed to reconstruct a point cloud with individual patches. Auxiliary patch info may include information about the position, size, and the like of a patch in a 2D/3D space.

Point cloud data according to the embodiments, for example, V-PCC components may include an atlas, an occupancy map, geometry, and attributes.

Atlas represents a set of 2D bounding boxes. It may be patches, for example, patches projected onto a rectangular frame. Atlas may correspond to a 3D bounding box in a 3D space, and may represent a subset of a point cloud.

An attribute may represent a scalar or vector associated with each point in the point cloud. For example, the attributes may include color, reflectance, surface normal, time stamps, material ID.

The point cloud data according to the embodiments represents PCC data according to video-based point cloud compression (V-PCC) scheme. The point cloud data may include a plurality of components. For example, it may include an occupancy map, a patch, geometry and/or texture.

FIG. 4 illustrates a V-PCC encoding process according to embodiments.

The figure illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each element of FIG. 4 may be performed by software, hardware, processor and/or a combination thereof.

The patch generation or patch generator 40000 receives a point cloud frame (which may be in the form of a bitstream containing point cloud data). The patch generator 40000 generates a patch from the point cloud data. In addition, patch information including information about patch generation is generated.

The patch packing or patch packer 40001 packs patches for point cloud data. For example, one or more patches may be packed. In addition, the patch packer generates an occupancy map containing information about patch packing.

The geometry image generation or geometry image generator 40002 generates a geometry image based on the point cloud data, patches, and/or packed patches. The geometry image refers to data containing geometry related to the point cloud data.

The texture image generation or texture image generator 40003 generates a texture image based on the point cloud data, patches, and/or packed patches. In addition, the texture image may be generated further based on smoothed geometry generated by smoothing processing of smoothing based on the patch information.

The smoothing or smoother 40004 may mitigate or eliminate errors contained in the image data. For example, based on the patched reconstructed geometry image, portions that may cause errors between data may be smoothly filtered out to generate smoothed geometry.

The auxiliary patch info compression or auxiliary patch info compressor 40005, auxiliary patch information related to the patch information generated in the patch generation is compressed. In addition, the compressed auxiliary patch information may be transmitted to the multiplexer. The auxiliary patch information may be used in the geometry image generation 40002.

The image padding or image padder 40006, 40007 may pad the geometry image and the texture image, respectively. The padding data may be padded to the geometry image and the texture image.

The group dilation or group dilator 40008 may add data to the texture image in a similar manner to image padding. The added data may be inserted into the texture image.

The video compression or video compressor 40009, 40010, 40011 may compress the padded geometry image, the padded texture image, and/or the occupancy map, respectively. The compression may encode geometry information, texture information, occupancy information, and the like.

The entropy compression or entropy compressor 40012 may compress (e.g., encode) the occupancy map based on an entropy scheme.

According to embodiments, the entropy compression and/or video compression may be performed, respectively depending on whether the point cloud data is lossless and/or lossy.

The multiplexer 40013 multiplexes the compressed geometry image, the compressed texture image, and the compressed occupancy map into a bitstream.

The specific operations in the respective processes of FIG. 4 are described below.

### Patch Generation 40000

The patch generation process refers to a process of dividing a point cloud into patches, which are mapping units, in order to map the point cloud to the 2D image. The patch generation process may be divided into three steps: normal value calculation, segmentation, and patch segmentation.

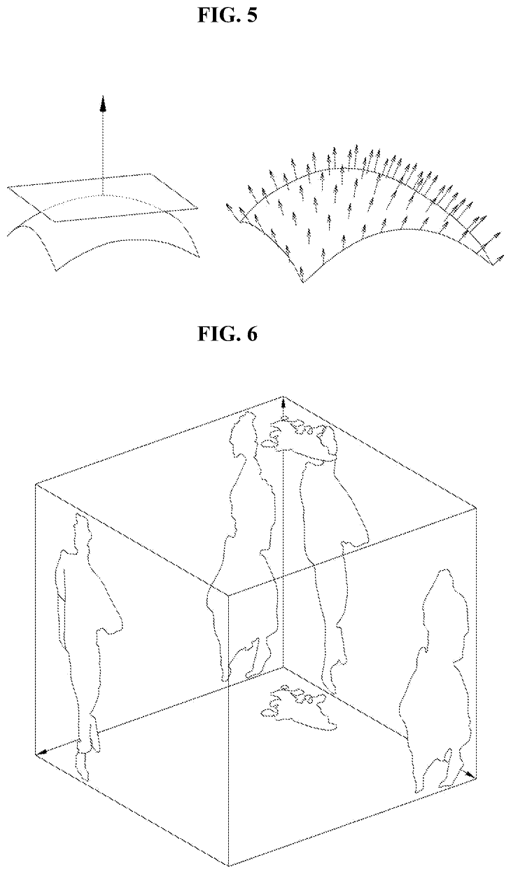

The normal value calculation process will be described in detail with reference to FIG. 5.

FIG. 5 illustrates an example of a tangent plane and a normal vector of a surface according to embodiments.

The surface of FIG. 5 is used in the patch generation process 40000 of the V-PCC encoding process of FIG. 4 as follows.

### Normal Calculation Related to Patch Generation:

Each point of a point cloud has its own direction, which is represented by a 3D vector called a normal vector. Using the neighbors of each point obtained using a K-D tree or the like, a tangent plane and a normal vector of each point constituting the surface of the point cloud as shown in the figure may be obtained. The search range applied to the process of searching for neighbors may be defined by the user.

The tangent plane refers to a plane that passes through a point on the surface and completely includes a tangent line to the curve on the surface.

FIG. 6 illustrates an exemplary bounding box of a point cloud according to embodiments.

A method/device according to embodiments, for example, patch generation, may employ a bounding box in generating a patch from point cloud data.

The bounding box according to the embodiments refers to a box of a unit for dividing point cloud data based on a hexahedron in a 3D space.

The bounding box may be used in the process of projecting a target object of the point cloud data onto a plane of each planar face of a hexahedron in a 3D space. The bounding box may be generated and processed by the point cloud video acquirer 10000 and the point cloud video encoder 10002 of FIG. 1. Further, based on the bounding box, the patch generation 40000, patch packing 40001, geometry image generation 40002, and texture image generation 40003 of the V-PCC encoding process of FIG. 2 may be performed.

### Segmentation Related to Patch Generation

Segmentation is divided into two processes: initial segmentation and refine segmentation.

The point cloud encoder 10002 according to the embodiments projects a point onto one face of a bounding box. Specifically, each point constituting a point cloud is projected onto one of the six faces of a bounding box surrounding the point cloud as shown in the figure. Initial segmentation is a process of determining one of the planar faces of the bounding box onto which each point is to be projected.

\vec{n}_{Pi}, which is a normal value corresponding to each of the six planar faces, is defined as follows:
(1.0, 0.0, 0.0), (0.0, 1.0, 0.0), (0.0, 0.0, 1.0), (−1.0, 0.0, 0.0), (0.0, −1.0, 0.0), (0.0, 0.0, −1.0).

As shown in the equation below, a face that yields the maximum value of dot product of the normal vector \vec{n}_{Pi} of each point, which is obtained in the normal value calculation process, and \hat{n}_{Pidx} is determined as a projection plane of the corresponding point. That is, a plane whose normal vector is most similar to the direction of the normal vector of a point is determined as the projection plane of the point.

$${max}_{{p}_{idx}} \{ {\vec{n}}_{{p}_{i}} \cdot {\vec{n}}_{{p}_{idx}} \}$$

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

### Patch Segmentation Related to Patch Generation

Patch segmentation is a process of dividing the entire point cloud into patches, which are sets of neighboring points, based on the projection plane information about each point constituting the point cloud obtained in the initial/refine segmentation process. The patch segmentation may include the following steps:
1) Calculate neighboring points of each point constituting the point cloud, using the K-D tree or the like. The maximum number of neighbors may be defined by the user;
2) When the neighboring points are projected onto the same plane as the current point (when they have the same cluster index), extract the current point and the neighboring points as one patch;
3) Calculate geometry values of the extracted patch. The details are described below; and
4) Repeat operations 2) to 4) until there is no unextracted point.

The occupancy map, geometry image and texture image for each patch as well as the size of each patch are determined through the patch segmentation process.

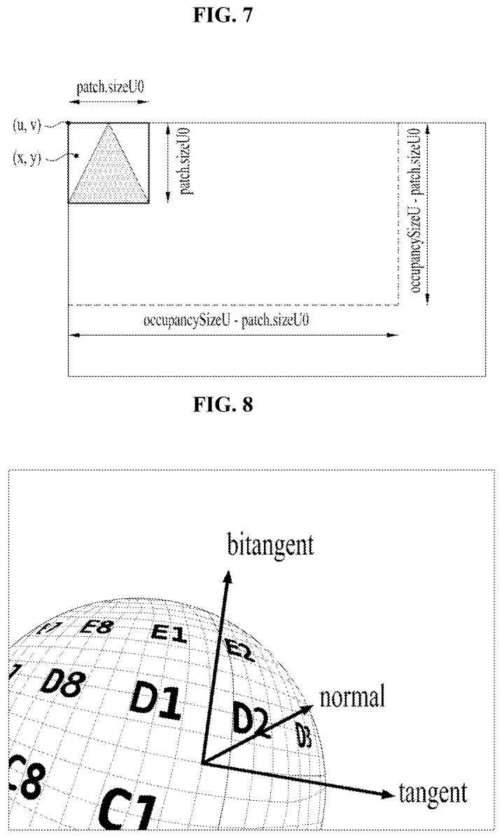

FIG. 7 illustrates an example of determination of individual patch positions on an occupancy map according to embodiments.

The point cloud encoder 10002 according to the embodiments may perform patch packing and generate an occupancy map.

### Patch Packing & Occupancy Map Generation (40001)

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:
1) Set all positions on the occupancy map to 0;
2) Place a patch at a point (u, v) having a horizontal coordinate within the range of (0, occupancySizeU−patch.sizeU0) and a vertical coordinate within the range of (0, occupancySizeV−patch.sizeV0) in the occupancy map plane;
3) Set a point (x, y) having a horizontal coordinate within the range of (0, patch.sizeU0) and a vertical coordinate within the range of (0, patch.sizeV0) in the patch plane as a current point;
4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);
5) Change the position of (u, v) in raster order and repeat operations 3) to 5);
6) Determine (u, v) as the position of the patch and copy the occupancy map data about the patch onto the corresponding portion on the global occupancy map; and
7) Repeat operations 2) to 7) for the next patch.
occupancySizeU: indicates the width of the occupancy map. The unit thereof is occupancy packing block size.
occupancySizeV: indicates the height of the occupancy map. The unit thereof is occupancy packing block size.
patch.sizeU0: indicates the width of the occupancy map. The unit thereof is occupancy packing block size.
patch.sizeV0: indicates the height of the occupancy map. The unit thereof is occupancy packing block size.

For example, as shown in FIG. 7, there is a box corresponding to a patch having a patch size in a box corresponding to an occupancy packing size block, and a point (x, y) may be located in the box.

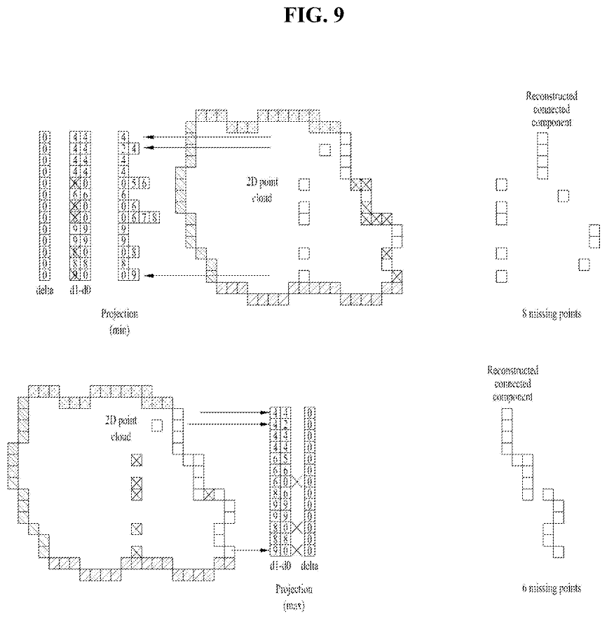

FIG. 8 shows an exemplary relationship among normal, tangent, and bitangent axes according to embodiments.

The point cloud encoder 10002 according to embodiments may generate a geometry image. The geometry image refers to image data including geometry information about a point cloud. The geometry image generation process may employ three axes (normal, tangent, and bitangent) of a patch in FIG. 8.

### Geometry Image Generation (40002)

In this process, the depth values constituting the geometry images of individual patches are determined, and the entire geometry image is generated based on the positions of the patches determined in the patch packing process described above. The process of determining the depth values constituting the geometry images of individual patches may be configured as follows.

1) Calculate parameters related to the position and size of an individual patch. The parameters may include the following information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in the figure.

FIG. 9 shows an exemplary configuration of the minimum mode and maximum mode of a projection mode according to embodiments.

The point cloud encoder 10002 according to embodiments may perform patch-based projection to generate a geometry image, and the projection mode according to the embodiments includes a minimum mode and a maximum mode.

3D spatial coordinates of a patch may be calculated based on the bounding box of the minimum size surrounding the patch. For example, the 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.

2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In the min mode, in generating the two layers of images d0 and d1, the minimum depth may be configured for d0, and the maximum depth within the surface thickness from the minimum depth may be configured for d1, as shown in the figure.

For example, when a point cloud is located in 2D as illustrated in the figure, there may be a plurality of patches including a plurality of points. As shown in the figure, it is indicated that points marked with the same style of shadow may belong to the same patch. The figure illustrates the process of projecting a patch of points marked with blanks.

When projecting points marked with blanks to the left/right, the depth may be incremented by 1 as 0, 1, 2, . . . , 6, 7, 8, 9 with respect to the left side, and the number for calculating the depths of the points may be marked on the right side.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected.

3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth1.

For example, a minimum value may be calculated in determining the depth of points of image d0 (4 2 4 4 0 6 0 0 9 9 0 8 0). In determining the depth of points of image d1, a greater value among two or more points may be calculated. When only one point is present, the value thereof may be calculated (4 4 4 4 6 6 6 8 9 9 8 8 9). In the process of encoding and reconstructing the points of the patch, some points may be lost (For example, in the figure, eight points are lost).

In the max mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image d1 is constructed with the value of depth1.

For example, a maximum value may be calculated in determining the depth of points of d0 (4 4 4 4 6 6 6 8 9 9 8 8 9). In addition, in determining the depth of points of d1, a lower value among two or more points may be calculated. When only one point is present, the value thereof may be calculated (4 2 4 4 5 6 0 6 9 9 0 8 0). In the process of encoding and reconstructing the points of the patch, some points may be lost (For example, in the figure, six points are lost).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 method) is to encode the depth values of the previously generated image d1. A second method (differential method) is to encode a difference between the depth values of previously generated image d1 and the depth values of image d0.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

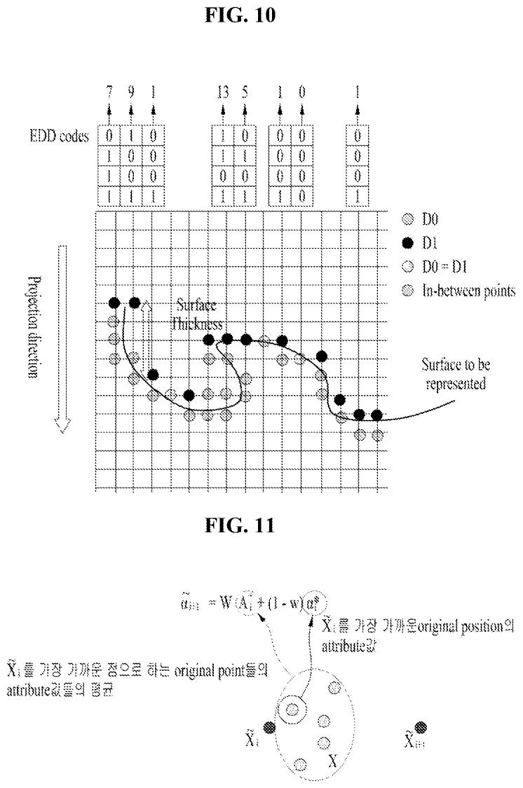

Hereinafter, the EDD code will be described in detail with reference to FIG. 10.

FIG. 10 illustrates an exemplary EDD code according to embodiments.

In some/all processes of the point cloud encoder 10002 and/or V-PCC encoding (e.g., video compression 40009), the geometry information about points may be encoded based on the EOD code.

As shown in the figure, the EDD code is used for binary encoding of the positions of all points within the range of surface thickness including d1. For example, in the figure, the points included in the second left column may be represented by an EDD code of 0b1001 (=9) because the points are present at the first and fourth positions over DO and the second and third positions are empty. When the EDD code is encoded together with DO and transmitted, a reception terminal may restore the geometry information about all points without loss.

For example, when there is a point present above a reference point, the value is 1. When there is no point, the value is 0. Thus, the code may be expressed based on 4 bits.

### Smoothing (40004)

Smoothing is an operation for eliminating discontinuity that may occur on the patch boundary due to deterioration of the image quality occurring during the compression process. Smoothing may be performed by the point cloud encoder or smoother:
1) Reconstruct the point cloud from the geometry image. This operation may be the reverse of the geometry image generation described above. For example, the reverse process of encoding may be reconstructed;
2) Calculate neighboring points of each point constituting the reconstructed point cloud using the K-D tree or the like;
3) Determine whether each of the points is positioned on the patch boundary. For example, when there is a neighboring point having a different projection plane (cluster index) from the current point, it may be determined that the point is positioned on the patch boundary;
4) If there is a point present on the patch boundary, move the point to the center of mass of the neighboring points (positioned at the average x, y, z coordinates of the neighboring points). That is, change the geometry value. Otherwise, maintain the previous geometry value.

FIG. 11 illustrates an example of recoloring based on color values of neighboring points according to embodiments.

The point cloud encoder or the texture image generator 40003 according to the embodiments may generate a texture image based on recoloring.

### Texture Image Generation (40003)

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in the figure, a new color value may be calculated in consideration of the color value of the nearest neighboring point and the color values of the neighboring points.

For example, referring to the figure, in the recoloring, a suitable color value for a changed position may be calculated based on the average of the attribute information about the closest original points to a point and/or the average of the attribute information about the closest original positions to the point.

Texture images may also be generated in two layers of t0 and t1, like the geometry images, which are generated in two layers of d0 and d1.

### Auxiliary Patch Info Compression (40005)

The point cloud encoder or the auxiliary patch info compressor according to the embodiments may compress the auxiliary patch information (auxiliary information about the point cloud).

The auxiliary patch info compressor compresses the auxiliary patch information generated in the patch generation, patch packing, and geometry generation processes described above. The auxiliary patch information may include the following parameters:
Index (cluster index) for identifying the projection plane (normal plane);
3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);
2D spatial position and size of the patch, i.e., the horizontal size (patch 2d size u), the vertical size (patch 2d size v), the minimum horizontal value (patch 2d shift u), and the minimum vertical value (patch 2d shift u); and
Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Table X shows a pseudo code representing the process of matching between blocks and patches based on the candidate list and the local patch indexes.

The maximum number of candidate lists may be defined by a user.

```
  for(i=0; i<BlockCount; i++) {
  if(candidatePatches[i].size( ) == 1) {
  blockToPatch[i] = candidatePatches[i][0] } else {
  candidate_index if(candidate_index == max_candidate_count){
  blockToPatch[i] =
local_patch_index } else {
  blockToPatch[i] = candidatePatches[i][candidate_index }}
```

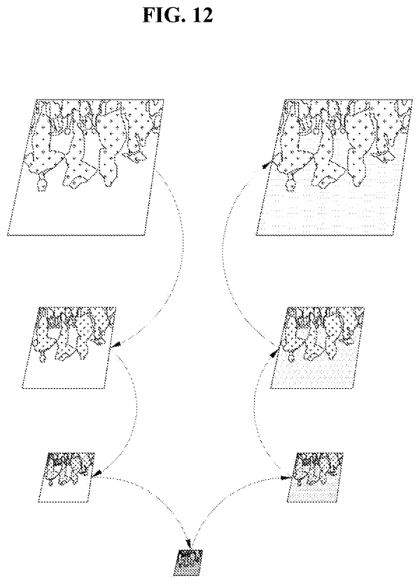

FIG. 12 illustrates push-pull background filling according to embodiments. Image padding and group dilation (40006, 40007, 40008)

The image padder according to the embodiments may fill the space except the patch area with meaningless supplemental data based on the push-pull background filling technique.

Image padding is a process of filling the space other than the patch region with meaningless data to improve compression efficiency. For image padding, pixel values in columns or rows close to a boundary in the patch may be copied to fill the empty space. Alternatively, as shown in the figure, a push-pull background filling method may be used. According to this method, the empty space is filled with pixel values from a low resolution image in the process of gradually reducing the resolution of a non-padded image and increasing the resolution again.

Group dilation is a process of filling the empty spaces of a geometry image and a texture image configured in two layers, d0/d1 and t0/t1, respectively. In this process, the empty spaces of the two layers calculated through image padding are filled with the average of the values for the same position.

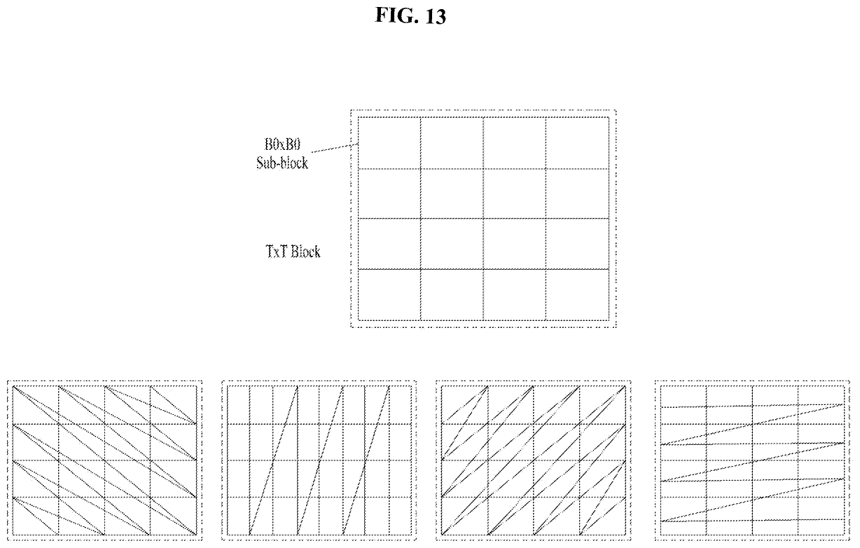

FIG. 13 shows an exemplary possible traversal order for a 4*4 block according to embodiments.

### Occupancy Map Compression (40012, 40011)

The occupancy map compressor according to the embodiments may compress the previously generated occupancy map. Specifically, two methods, namely video compression for lossy compression and entropy compression for lossless compression, may be used. Video compression is described below.

The entropy compression may be performed through the following operations.
1) If a block constituting an occupancy map is fully occupied, encode 1 and repeat the same operation for the next block of the occupancy map. Otherwise, encode 0 and perform operations 2) to 5).
2) Determine the best traversal order to perform run-length coding on the occupied pixels of the block. The figure shows four possible traversal orders for a 4*4 block.

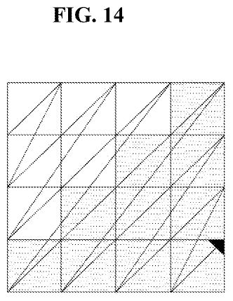

FIG. 14 illustrates an exemplary best traversal order according to embodiments.

As described above, the entropy compressor according to the embodiments may code (encode) a block based on the traversal order scheme as described above.

For example, the best traversal order with the minimum number of runs is selected from among the possible traversal orders and the index thereof is encoded. The figure illustrates a case where the third traversal order in FIG. 13 is selected. In the illustrated case, the number of runs may be minimized to 2, and therefore the third traversal order may be selected as the best traversal order.
3) Encode the number of runs. In the example of FIG. 14, there are two runs, and therefore 2 is encoded.
4) Encode the occupancy of the first run. In the example of FIG. 14, 0 is encoded because the first run corresponds to unoccupied pixels.
5) Encode lengths of the individual runs (as many as the number of runs). In the example of FIG. 14, the lengths of the first run and the second run, 6 and 10, are sequentially encoded.

### Video Compression (40009, 40010, 40011)

The video compressor according to the embodiments encodes a sequence of a geometry image, a texture image, an occupancy map image, and the like generated in the above-described operations, using a 2D video codec such as HEVC or VVC.

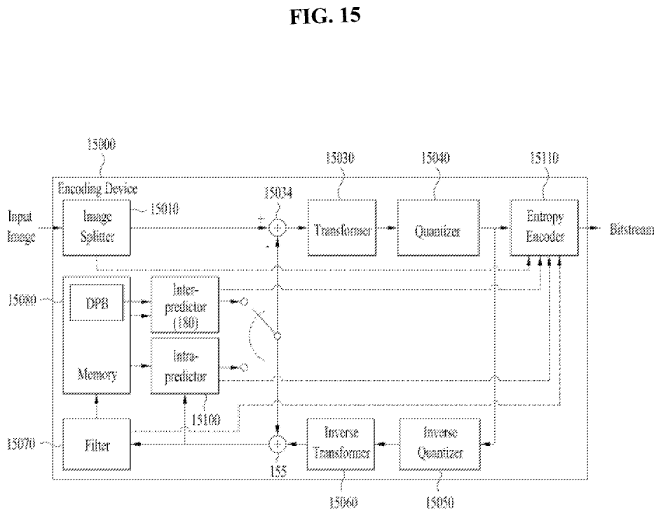

FIG. 15 illustrates an exemplary 2D video/image encoder according to embodiments.

The figure, which represents an embodiment to which the video compression or video compressor 40009, 40010, and 40011 described above is applied, is a schematic block diagram of a 2D video/image encoder 15000 configured to encode a video/image signal. The 2D video/image encoder 15000 may be included in the point cloud video encoder described above or may be configured as an internal/external component. Each component of FIG. 15 may correspond to software, hardware, processor and/or a combination thereof.

Here, the input image may include the geometry image, the texture image (attribute(s) image), and the occupancy map image described above. The output bitstream (i.e., the point cloud video/image bitstream) of the point cloud video encoder may include output bitstreams for the respective input images (i.e., the geometry image, the texture image (attribute(s) image), the occupancy map image, etc.).

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be included in the residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 155, the filter 15070, the inter-predictor 15090, the intra-predictor 15100, and the entropy encoder 15110 described above may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The encoder 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. In this case, as shown in the figure, the unit that subtracts the prediction signal (predicted block or predicted sample array) from the input image signal (original block or original sample array) in the encoder 15000 may be called a subtractor 15020. The predictor may perform prediction for a processing target block (hereinafter referred to as a current block) and generate a predicted block including prediction samples for the current block. The predictor may determine whether intra-prediction or inter-prediction is applied on a current block or CU basis. As will be described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loeve transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector. The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis. The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 155 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 155 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture transmitted to the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse coding mode (PCM) is applied, the prediction, transform, and quantization procedures may be skipped, and the value of the original sample may be encoded and output in the form of a bitstream.

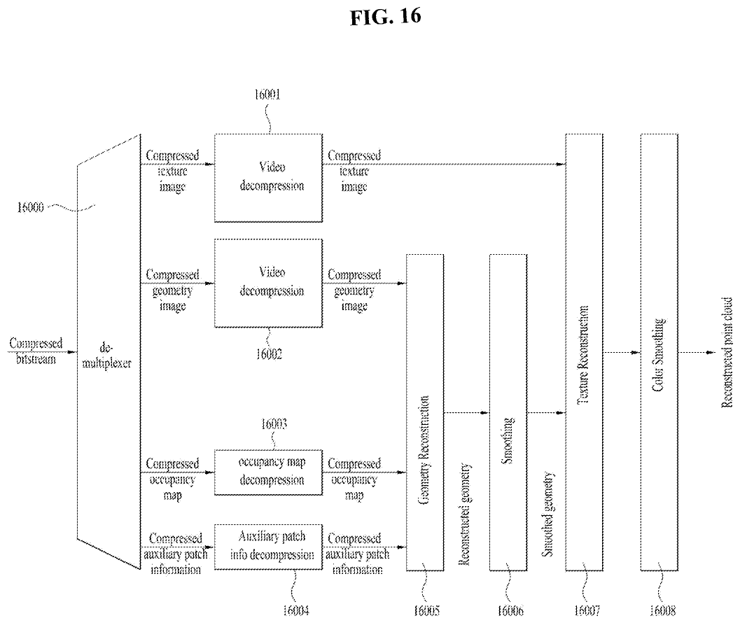

FIG. 16 illustrates an exemplary V-PCC decoding process according to embodiments.

The V-PCC decoding process or V-PCC decoder may follow the reverse process of the V-PCC encoding process (or encoder) of FIG. 4. Each component in FIG. 16 may correspond to software, hardware, a processor, and/or a combination thereof.

The demultiplexer 16000 demultiplexes the compressed bitstream to output a compressed texture image, a compressed geometry image, a compressed occupancy map, and compressed auxiliary patch information.

The video decompression or video decompressor 16001, 16002 decompresses (or decodes) each of the compressed texture image and the compressed geometry image.

The occupancy map decompression or occupancy map decompressor 16003 decompresses the compressed occupancy map.

The auxiliary patch info decompression or auxiliary patch info decompressor 16004 decompresses auxiliary patch information.

The geometry reconstruction or geometry reconstructor 16005 restores (reconstructs) the geometry information based on the decompressed geometry image, the decompressed occupancy map, and/or the decompressed auxiliary patch information. For example, the geometry changed in the encoding process may be reconstructed.

The smoothing or smoother 16006 may apply smoothing to the reconstructed geometry. For example, smoothing filtering may be applied.

The texture reconstruction or texture reconstructor 16007 reconstructs the texture from the decompressed texture image and/or the smoothed geometry.

The color smoothing or color smoother 16008 smoothes color values from the reconstructed texture. For example, smoothing filtering may be applied.

As a result, reconstructed point cloud data may be generated.

The figure illustrates a decoding process of the V-PCC for reconstructing a point cloud by decoding the compressed occupancy map, geometry image, texture image, and auxiliary path information. Each process according to the embodiments is operated as follows.

### Video Decompression (16001, 16002)

Video decompression is a reverse process of the video compression described above. In video decompression, a 2D video codec such as HEVC or VVC is used to decode a compressed bitstream containing the geometry image, texture image, and occupancy map image generated in the above-described process.

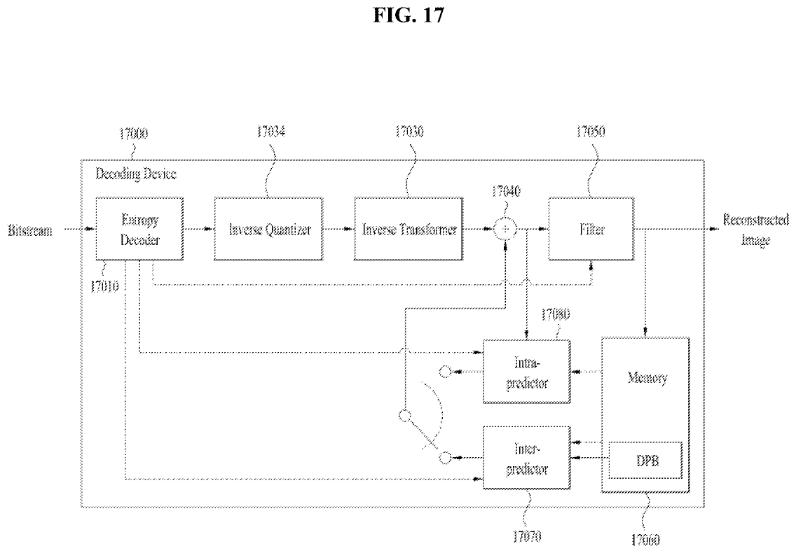

FIG. 17 illustrates an exemplary 2D video/image decoder according to embodiments.

The 2D video/image decoder may follow the reverse process of the 2D video/image encoder of FIG. 15.

The 2D video/image decoder of FIG. 17 is an embodiment of the video decompression or video decompressor of FIG. 16. FIG. 17 is a schematic block diagram of a 2D video/image decoder 17000 by which decoding of a video/image signal is performed. The 2D video/image decoder 17000 may be included in the point cloud video decoder of FIG. 1, or may be configured as an internal/external component. Each component in FIG. 17 may correspond to software, hardware, a processor, and/or a combination thereof.

Here, the input bitstream may include bitstreams for the geometry image, texture image (attribute(s) image), and occupancy map image described above. The reconstructed image (or the output image or the decoded image) may represent a reconstructed image for the geometry image, texture image (attribute(s) image), and occupancy map image described above.

Referring to the figure, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 described above may be configured by one hardware component (e.g., a decoder or a processor) according to an embodiment. In addition, the memory 170 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 1. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 265 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal. For example, the filter 17050 may generate a modified reconstructed picture by applying various filtering techniques to the reconstructed picture, and may transmit the modified reconstructed picture to the memory 250, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 160, the inter-predictor 180, and the intra-predictor 185 of the encoding device 100 may be applied to the filter 17050, the inter-predictor 17070 and the intra-predictor 17080 of the decoder 17000, respectively, in the same or corresponding manner.

At least one of the prediction, transform, and quantization procedures described above may be skipped. For example, for a block to which the pulse coding mode (PCM) is applied, the prediction, transform, and quantization procedures may be skipped, and the value of a decoded sample may be used as a sample of the reconstructed image.

### Occupancy Map Decompression (16003)

This is a reverse process of the occupancy map compression described above. Occupancy map decompression is a process for reconstructing the occupancy map by decompressing the occupancy map bitstream.

### Auxiliary Patch Info Decompression (16004)

The auxiliary patch information may be reconstructed by performing the reverse process of the aforementioned auxiliary patch info compression and decoding the compressed auxiliary patch info bitstream.

### Geometry Reconstruction (16005)

This is a reverse process of the geometry image generation described above. Initially, a patch is extracted from the geometry image using the reconstructed occupancy map, the 2D position/size information about the patch included in the auxiliary patch info, and the information about mapping between a block and the patch. Then, a point cloud is reconstructed in a 3D space based on the geometry image of the extracted patch and the 3D position information about the patch included in the auxiliary patch info. When the geometry value corresponding to a point (u, v) within the patch is g(u, v), and the coordinates of the position of the patch on the normal, tangent and bitangent axes of the 3D space are (δ0, s0, r0), □δ(u, v), s(u, v), and r(u, v), which are the normal, tangent, and bitangent coordinates in the 3D space of a position mapped to point (u, v) may be expressed as follows:

$$δ ( u , v ) = δ 0 + g ( u , v ) ; \\ s ( u , v ) = s 0 + u ; \\ r ( u , v ) = r 0 + v .$$

### Smoothing (16006)

Smoothing, which is the same as the smoothing in the encoding process described above, is a process for eliminating discontinuity that may occur on the patch boundary due to deterioration of the image quality occurring during the compression process.

### Texture Reconstruction (16007)

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the mapping information about the geometry image and the point cloud in the geometry reconstruction process described above.

### Color Smoothing (16008)

Color smoothing is similar to the process of geometry smoothing described above. Color smoothing is a process for eliminating discontinuity that may occur on the patch boundary due to deterioration of the image quality occurring during the compression process. Color smoothing may be performed through the following operations:
1) Calculate neighboring points of each point constituting the reconstructed point cloud using the K-D tree or the like. The neighboring point information calculated in the geometry smoothing process described in section 2.5 may be used.
2) Determine whether each of the points is positioned on the patch boundary. These operations may be performed based on the boundary information calculated in the geometry smoothing process described above.
3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

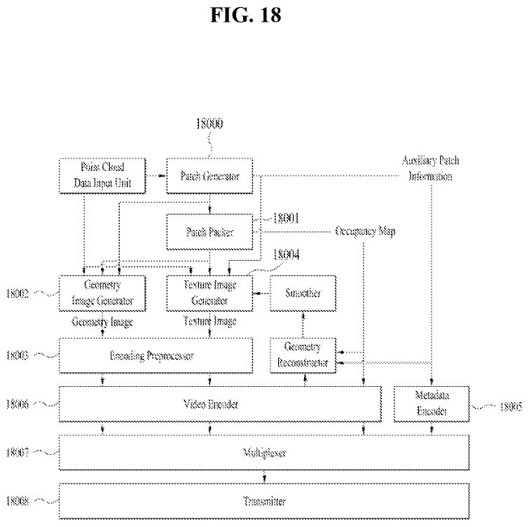

FIG. 18 is a flowchart illustrating operation of a transmission device according to embodiments of the present disclosure.

The transmission device according to the embodiments may correspond to the transmission device of FIG. 1, the encoding process of FIG. 4, and the 2D video/image encoder of FIG. 15, or perform some/all of the operations thereof. Each component of the transmission device may correspond to software, hardware, a processor and/or a combination thereof.

An operation process of the transmission terminal for compression and transmission of point cloud data using V-PCC may be performed as illustrated in the figure.

The point cloud data transmission device according to the embodiments may be referred to as a transmission device.

Regarding a patch generator 18000, a patch for 2D image mapping of a point cloud is generated. Auxiliary patch information is generated as a result of the patch generation. The generated information may be used in the processes of geometry image generation, texture image generation, and geometry reconstruction for smoothing.

Regarding a patch packer 18001, a patch packing process of mapping the generated patches into the 2D image is performed. As a result of patch packing, an occupancy map may be generated. The occupancy map may be used in the processes of geometry image generation, texture image generation, and geometry reconstruction for smoothing.

A geometry image generator 18002 generates a geometry image based on the auxiliary patch information and the occupancy map. The generated geometry image is encoded into one bitstream through video encoding.

An encoding preprocessor 18003 may include an image padding procedure. The geometry image regenerated by decoding the generated geometry image or the encoded geometry bitstream may be used for 3D geometry reconstruction and then be subjected to a smoothing process.

A texture image generator 18004 may generate a texture image based on the (smoothed) 3D geometry, the point cloud, the auxiliary patch information, and the occupancy map. The generated texture image may be encoded into one video bitstream.

A metadata encoder 18005 may encode the auxiliary patch information into one metadata bitstream.

A video encoder 18006 may encode the occupancy map into one video bitstream.

A multiplexer 18007 may multiplex the video bitstreams of the generated geometry image, texture image, and occupancy map and the metadata bitstream of the auxiliary patch information into one bitstream.

A transmitter 18008 may transmit the bitstream to the reception terminal. Alternatively, the video bitstreams of the generated geometry image, texture image, and the occupancy map and the metadata bitstream of the auxiliary patch information may be processed into a file of one or more track data or encapsulated into segments and may be transmitted to the reception terminal through the transmitter.

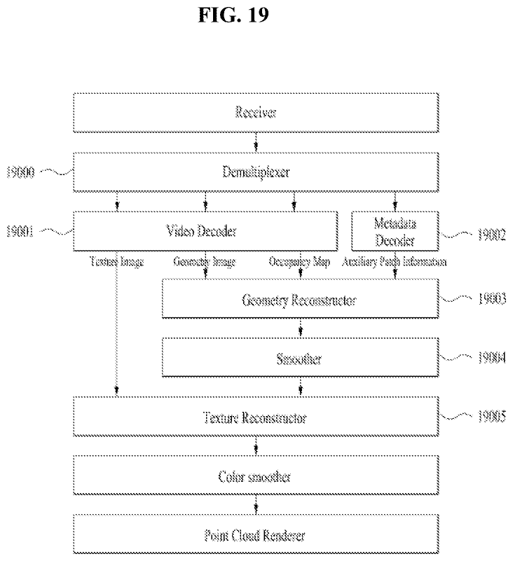

FIG. 19 is a flowchart illustrating operation of a reception device according to embodiments.

The reception device according to the embodiments may correspond to the reception device of FIG. 1, the decoding process of FIG. 16, and the 2D video/image encoder of FIG. 17, or perform some/all of the operations thereof. Each component of the reception device may correspond to software, hardware, a processor and/or a combination thereof.

The operation of the reception terminal for receiving and reconstructing point cloud data using V-PCC may be performed as illustrated in the figure. The operation of the V-PCC reception terminal may follow the reverse process of the operation of the V-PCC transmission terminal of FIG. 18.

The point cloud data reception device according to the embodiments may be referred to as a reception device.

The bitstream of the received point cloud is demultiplexed into the video bitstreams of the compressed geometry image, texture image, occupancy map and the metadata bitstream of the auxiliary patch information by a demultiplexer 19000 after file/segment decapsulation. A video decoder 19001 and a metadata decoder 19002 decode the demultiplexed video bitstreams and metadata bitstream. 3D geometry is reconstructed by a geometry reconstructor 19003 based on the decoded geometry image, occupancy map, and auxiliary patch information, and is then subjected to a smoothing process performed by a smoother 19004. A color point cloud image/picture may be reconstructed by a texture reconstructor 19005 by assigning color values to the smoothed 3D geometry based on the texture image. Thereafter, a color smoothing process may be additionally performed to improve the objective/subjective visual quality, and a modified point cloud image/picture derived through the color smoothing process is shown to the user through the rendering process (through, for example, the point cloud renderer). In some cases, the color smoothing process may be skipped.

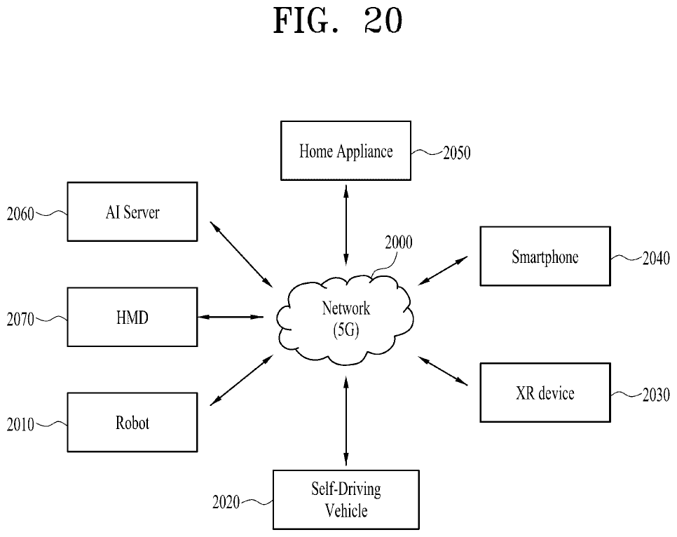

FIG. 20 illustrates an exemplary structure operable in connection with point cloud data transmission/reception methods/devices according to embodiments.

In the structure according to the embodiments, at least one of a server 2060, a robot 2010, a self-driving vehicle 2020, an XR device 2030, a smartphone 2040, a home appliance 2050 and/or a head-mount display (HMD) 2070 is connected to a cloud network 2010. Here, the robot 2010, the self-driving vehicle 2020, the XR device 2030, the smartphone 2040, or the home appliance 2050 may be referred to as a device. In addition, the XR device 2030 may correspond to a point cloud data (PCC) device according to embodiments or may be operatively connected to the PCC device.

The cloud network 2000 may represent a network that constitutes part of the cloud computing infrastructure or is present in the cloud computing infrastructure. Here, the cloud network 2000 may be configured using a 3G network, 4G or Long Term Evolution (LTE) network, or a 5G network.

The server 2060 may be connected to at least one of the robot 2010, the self-driving vehicle 2020, the XR device 2030, the smartphone 2040, the home appliance 2050, and/or the HMD 2070 over the cloud network 2000 and may assist at least a part of the processing of the connected devices 2010 to 2070.

The HMD 2070 represents one of the implementation types of the XR device and/or the PCC device according to the embodiments. An HMD type device according to embodiments includes a communication unit, a control unit, a memory, an I/O unit, a sensor unit, and a power supply unit.

Hereinafter, various embodiments of the devices 2010 to 2050 to which the above-described technology is applied will be described. The devices 2010 to 2050 illustrated in FIG. 20 may be operatively connected/coupled to a point cloud data transmission and reception device according to the above-described embodiments.

<PCC+XR> The XR/PCC device 2030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 2030 may analyze 3D point cloud data or image data acquired through various sensors or from an external device and generate position data and attribute data about 3D points. Thereby, the XR/PCC device 2030 may acquire information about the surrounding space or a real object, and render and output an XR object. For example, the XR/PCC device 2030 may match an XR object including auxiliary information about a recognized object with the recognized object and output the matched XR object.

<PCC+Self-driving+XR> The self-driving vehicle 2020 may be implemented as a mobile robot, a vehicle, an unmanned aerial vehicle, or the like by applying the PCC technology and the XR technology.

The self-driving vehicle 2020 to which the XR/PCC technology is applied may represent an autonomous vehicle provided with means for providing an XR image, or an autonomous vehicle that is a target of control/interaction in the XR image. In particular, the self-driving vehicle 2020, which is a target of control/interaction in the XR image, may be distinguished from the XR device 2030 and may be operatively connected thereto.

The self-driving vehicle 2020 having means for providing an XR/PCC image may acquire sensor information from the sensors including a camera, and output the generated XR/PCC image based on the acquired sensor information. For example, the self-driving vehicle may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to a vehicle that provides a self-driving service.

A vehicle that provides the self-driving service is connected to a PCC device for wired/wireless communication.

When the point cloud data transmission and reception device (PCC device) according to the embodiments is connected to a vehicle for wired/wireless communication, the device may receive and process content data related to an AR/VR/PCC service that may be provided together with the self-driving service and transmit the processed content data to the vehicle. In the case where the point cloud data transmission and reception device is mounted on a vehicle, the point cloud transmitting and reception device may receive and process content data related to the AR/VR/PCC service according to a user input signal input through a user interface device and provide the processed content data to the user. The vehicle or the user interface device according to the embodiments may receive a user input signal. The user input signal according to the embodiments may include a signal indicating the self-driving service.

The point cloud data transmission method and device, reception method and device according to embodiments may be referred to as the method/device according to embodiments for short.

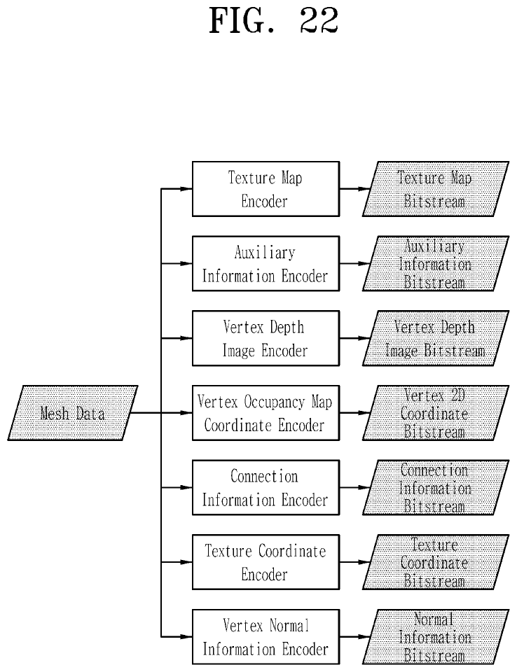

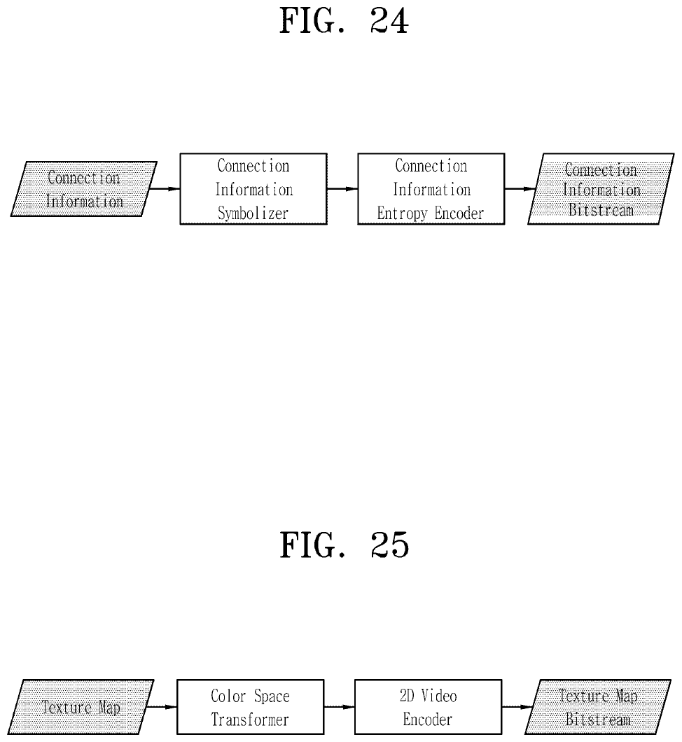

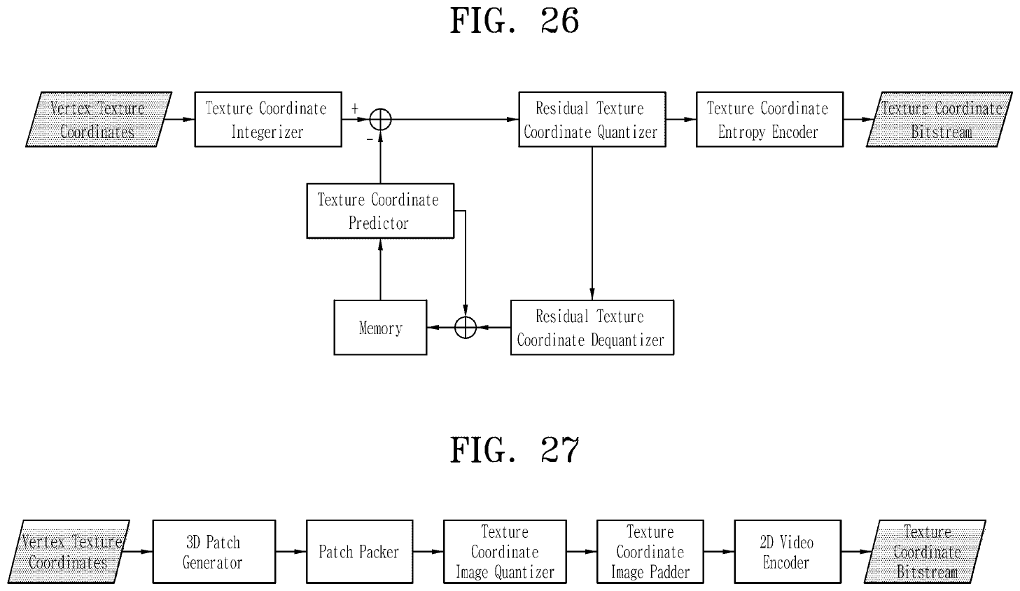

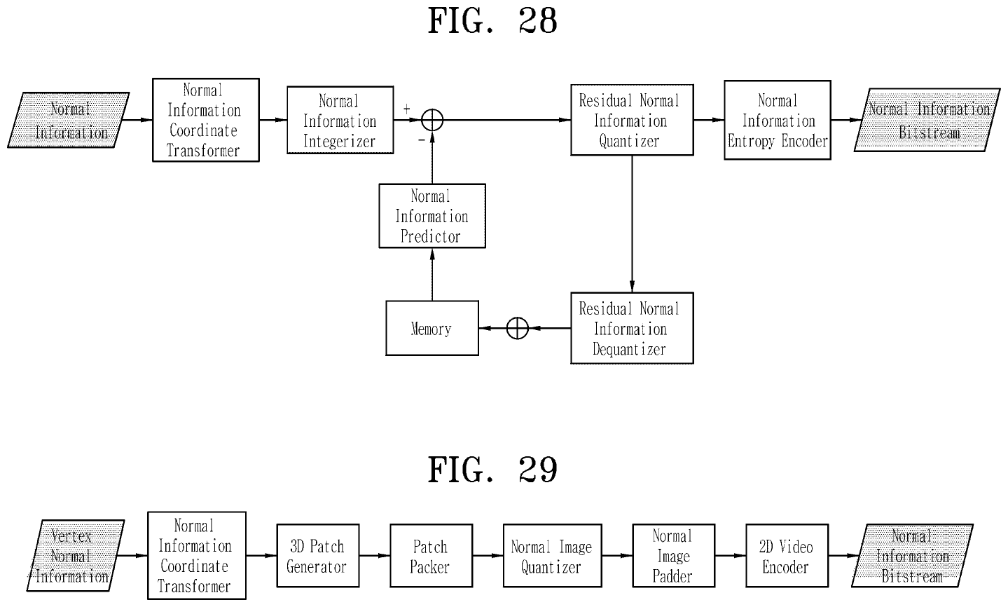

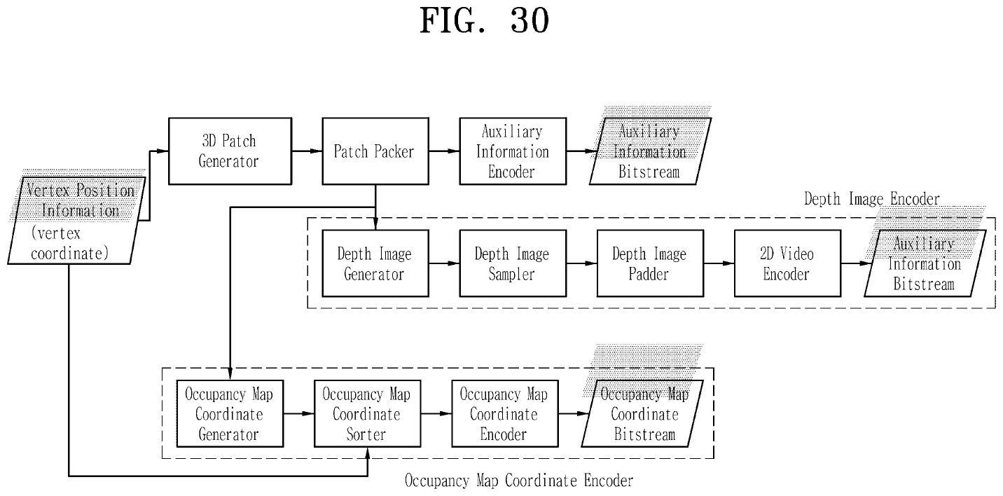

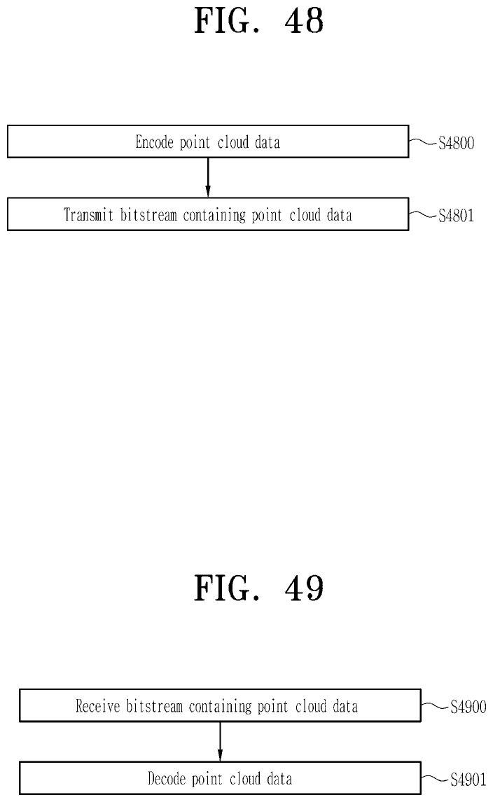

The point cloud data transmission method/device according to the embodiments corresponds to the transmission device 1000, point cloud video encoder 10002, file/segment encapsulator 10003, transmitter 10004 of FIG. 1, the encoder of FIG. 4, the encoder of FIG. 15, the transmission device of FIG. 18, the XR device 2030 of FIG. 20, the mesh encoder of FIG. 22, the connection information encoder of FIG. 24, the texture map encoder of FIG. 25, the vertex texture coordinate encoder of FIG. 26, the vertex texture encoder of FIG. 27, the normal information encoder of FIG. 28, the normal information encoder of FIG. 29, the auxiliary information encoder, depth image, and occupancy map coordinate encoders of FIG. 30, the occupancy map coordinate information encoder of FIG. 32, the point cloud data transmission method of FIG. 48, and the like.

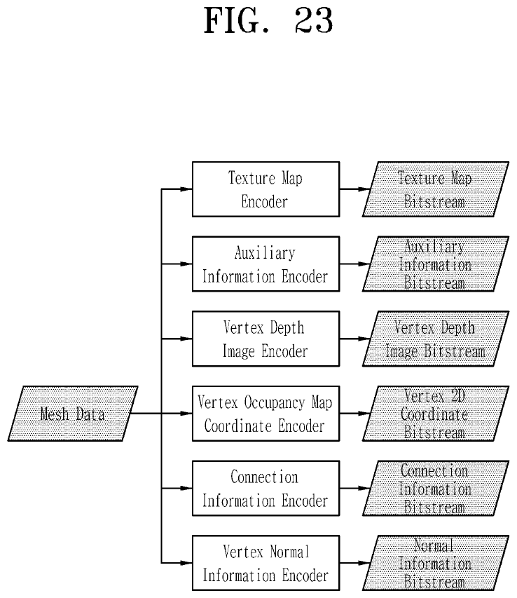

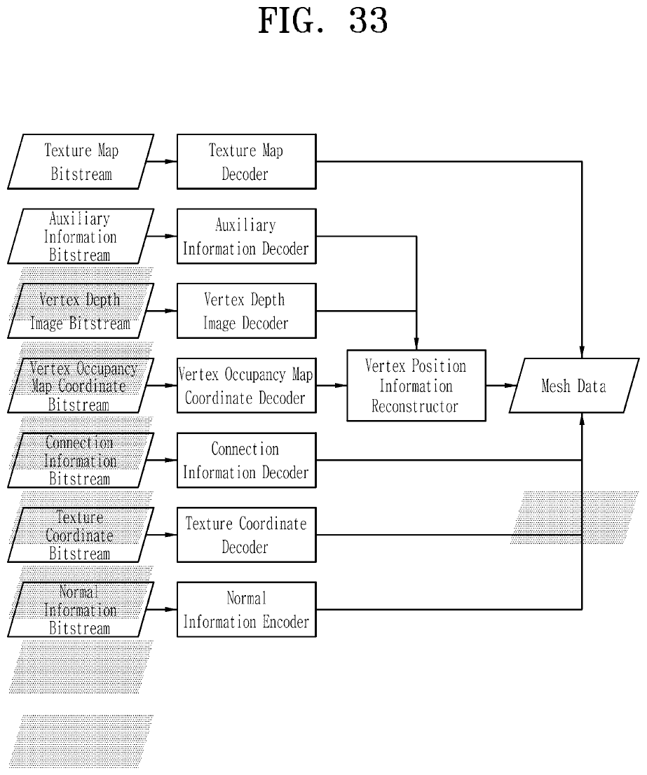

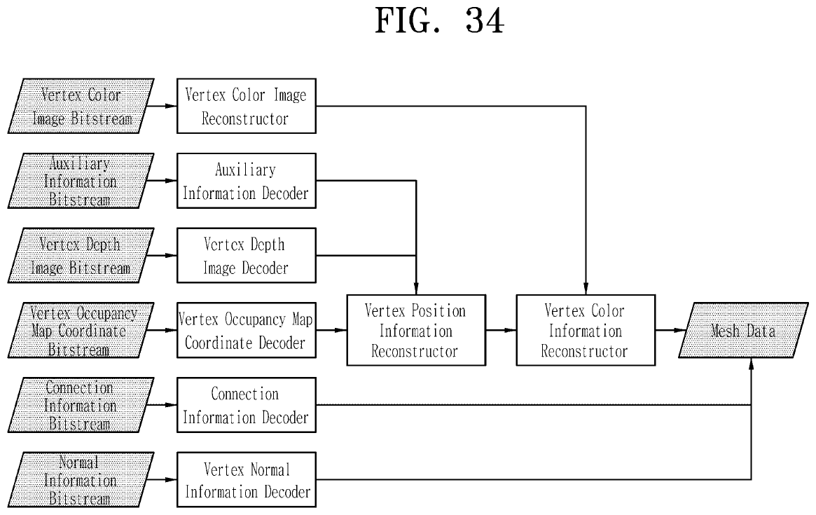

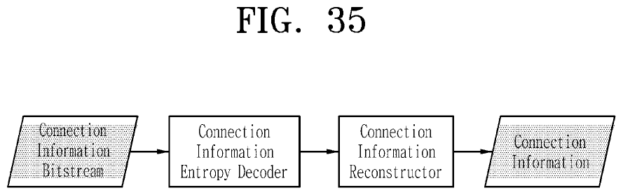

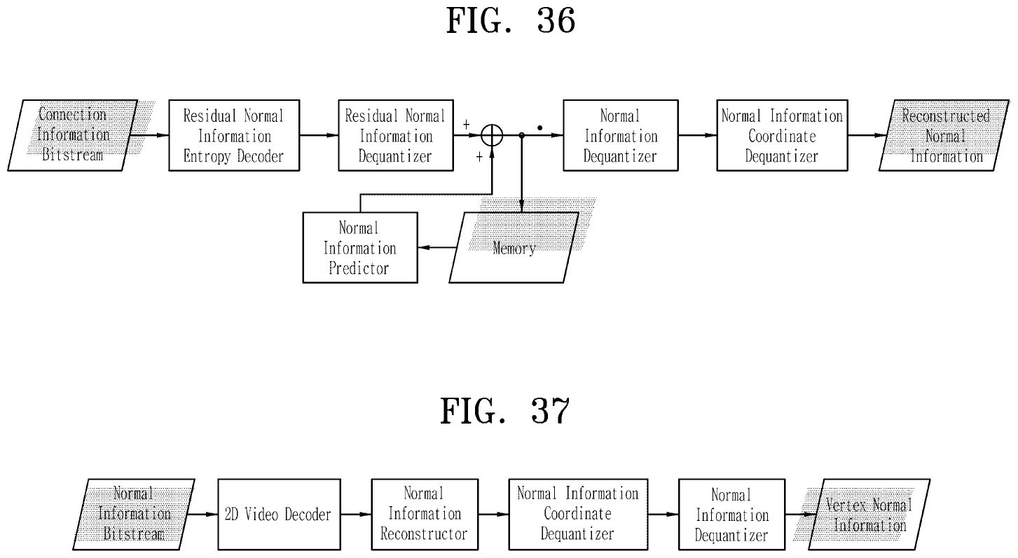

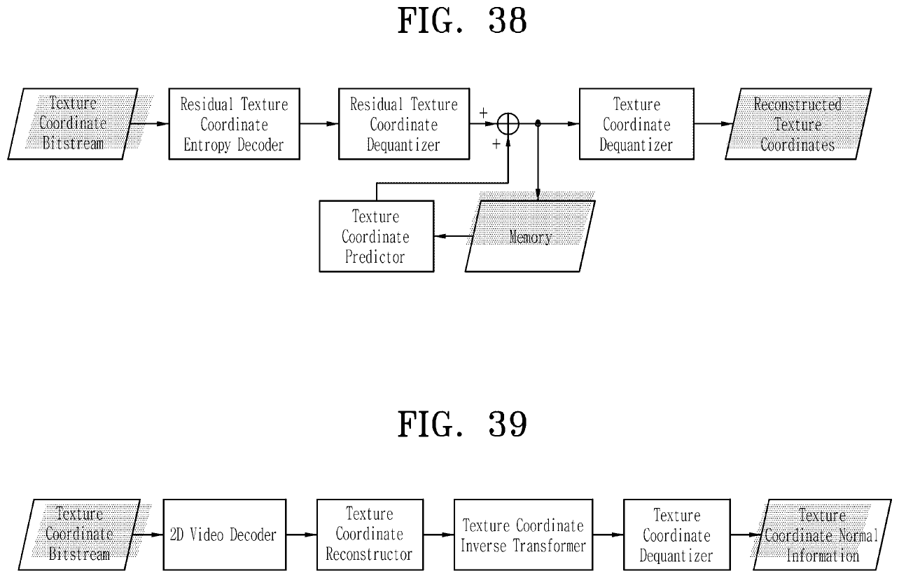

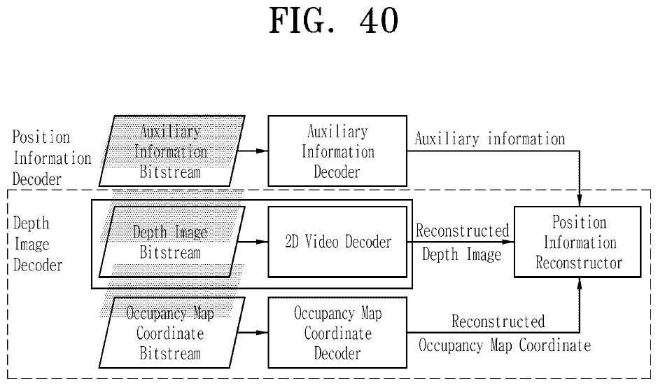

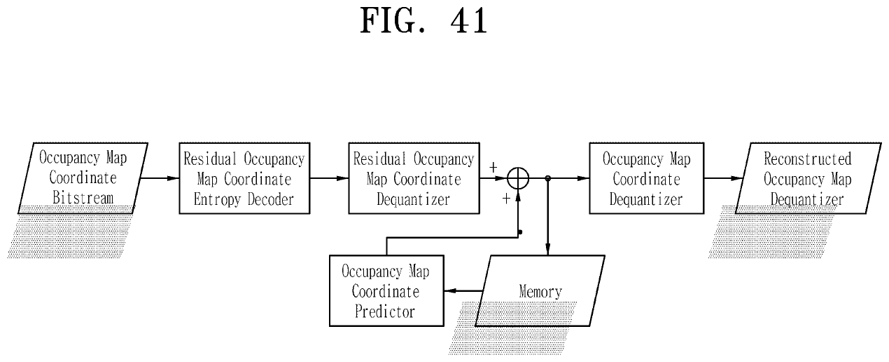

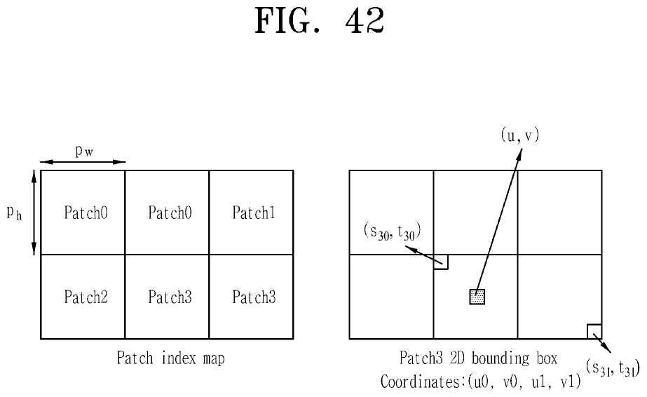

The point cloud data reception method/device according to the embodiments corresponds to the reception device 10005, point cloud video decoder 10008, file/segment decapsulator 10007, and receiver 10006 of FIG. 1, the decoder of FIGS. 16 and 17, the reception device of FIG. 19, the XR device 2030 of FIG. 20, the mesh encoder of FIG. 23, the mesh data decoder of FIGS. 33 and 34, the connection information decoder of FIG. 35, the normal information decoder of FIG. 36, the normal information decoder of FIG. 37, the texture coordinate decoder of FIG. 38, the texture coordinate decoder of FIG. 39, the auxiliary information decoder and position information decoder of FIG. 40, the occupancy map coordinate decoder of FIG. 41, the point cloud data reception method of FIG. 49, and the like.

The method/device according to the embodiments may include and perform mesh geometry data compression based on video encoding.

Embodiments relate to video-based point cloud compression (V-PCC), a method of compressing three-dimensional point cloud data using a 2D video codec. Related techniques are proposed to enable the point cloud data compressed by V-PCC to be reconstructed and displayed at the receiving side. In general, to display point cloud data, it is converted into 3D mesh data. The existing V-PCC standard method does not include a mesh information processor, and therefore a separate process or system is added depending on the application used to transmit mesh information. Therefore, if the encoding order of the connection information and the encoding order of the vertex information do not match in compressing three-dimensional dynamic mesh data, a mapping table must be transmitted for each vertex to match the vertex index of the restored vertex information with the vertex index of the restored connection information. In this case, the dynamic range of the mapping table transmitted is 0 to N (the number of vertices), and the amount of data to be transmitted becomes very large, which makes it difficult to compress the data efficiently.

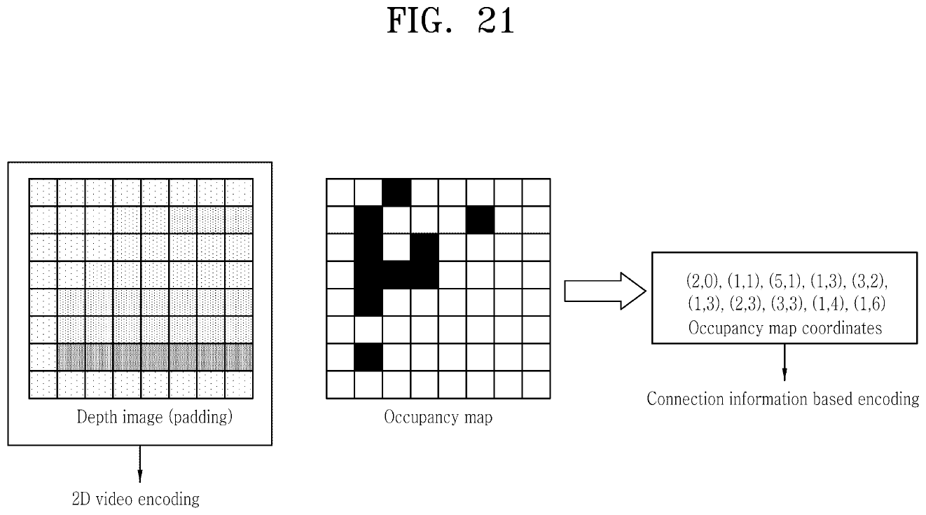

FIG. 21 illustrates encoding and decoding based on connection information in encoding and/or decoding an occupancy map according to embodiments.

As shown in FIG. 21, the method/device according to the embodiments may generate a mapping table for mapping restored vertices and restored connection information in encoding 3D dynamic mesh data based on a 2D video encoder. Further, the method/device according to the embodiments may include and perform a method of efficiently encoding/decoding vertex position information without the need for separate transmission of such a mapping table.

For vertex information in dynamic mesh data, embodiments may compress the depth image through a 2D encoder and encode the occupancy map coordinates of the vertices in order of connection information encoding to efficiently encode/decode vertex information and connection information without transmitting a mapping table for each vertex.

In embodiments, the occupancy map itself may not be encoded for transmission. In other words, in embodiments, a mapping list for the occupancy map may be generated and transmitted. By encoding and transmitting only the occupancy map coordinates, and transmitting the coordinates in order, there is no need to send a separate mapping table.

The embodiments relate to encoding/decoding methods for processing mesh data during V-PCC encoding/decoding. The 2D video encoder may be used to compress the depth image, thereby efficiently removing temporal/spatial redundancy of depth information.

The V-PCC encoding/decoding standard can only efficiently encode/decode point cloud data. It cannot process the main information of 3D mesh data and requires a separate device or post-processing to process the data into mesh data or decode/encode the unsupported information separately.

In this process, if the encoding order of the connection information and the encoding order of the vertex information do not match in compressing dimensional dynamic mesh data, it is necessary to transmit separate data in the form of a mapping table for each vertex to match the vertex index of the restored vertex information with the vertex index of the restored connection information. In this case, the dynamic range of the mapping table transmitted is 0 to N (the number of vertices), and the amount of data to be transmitted becomes large, which adversely affects compression efficiency and performance.

In addition, if the vertex position information (x,y,z) is compressed in the encoding order of the connection information, it is impossible to eliminate the temporal redundancy of the vertex information.

Therefore, the present disclosure proposes a structure in which the depth image of the vertex information related to dynamic mesh data is compressed by a 2D encoder, and the occupancy map coordinates of the vertex are encoded in the encoding order of the connection information, such that the vertex information and connection information can be efficiently decoded without the need to transmit a mapping table for each vertex.

For sparse mesh data, the depth image may be down-sampled and transmitted, and the decoder may perform up-sampling based on the reconstructed occupancy map coordinates, thereby enabling efficient encoding and decoding of position information while maintaining the total number of vertices. (As of the MPEG mesh cfp in December 2021, it has been decided that the official data should only consist of sparse mesh data).

The term V-PCC used herein has the same meaning as visual volumetric video-based coding (V3C), and both terms may be used interchangeably. Therefore, the term V-PCC may be construed as V3C

Embodiments can be modified and combined. The terms used herein are to be understood based on their intended meaning, to the extent that they are widely used in the art.

Hereinafter, a transmission device and a method for the transmission device according to embodiments will be described.

For V-PCC-based mesh data compression, mesh data is defined in the following mesh data form.
Category 1: Mesh data having a texture map as color information
Category 2: Mesh data having vertex colors as color information

FIG. 22 illustrates a mesh data encoder having a texture map as color information according to embodiments

The mesh data encoder of FIG. 22 may be included in and correspond to the transmission device 1000, point cloud video encoder 10002, file/segment encapsulator 10003, transmitter 10004 of FIG. 1, the encoder of FIG. 4, the encoder of FIG. 15, the transmission device of FIG. 18, the XR device 2030 of FIG. 20, the mesh encoder of FIG. 22, the connection information encoder of FIG. 24, and the texture map encoder of FIG. 25, the vertex texture coordinate encoder of FIG. 26, the vertex texture encoder of FIG. 27, the normal information encoder of FIG. 28, the normal information encoder of FIG. 29, the auxiliary information encoder, depth image encoder, occupancy map coordinate encoder of FIG. 30, the occupancy map coordinate information encoder of FIG. 32, the point cloud data transmission method of FIG. 48, and the like. Each of the components of FIG. 22 may correspond to hardware, software, a processor, and/or a combination thereof.

FIG. 23 illustrates a mesh data encoder having a texture map (category 1) as color information.

The vertex depth image is data organized as a 2D image of the distance information between the vertices and the projection plane.

Vertex occupancy map coordinates are 2D coordinate information about occupied pixels in the occupancy map.

Mesh data having a texture map as color information may include vertex geometry information, connection information, texture map, vertex normal information, and/or vertex texture coordinate information.

Vertex position information (x,y,z) related to the mesh data may be divided into depth image, which represents the distance of the corresponding pixel from the projection plane in projection into a 2D image, and vertex occupancy map coordinates, which are the coordinate information in the occupancy map generated by projection and packing.

The texture map encoder may encode the texture map (color information, category 1).

The depth image encoder encodes the depth image through a 2D video encoder.

The vertex occupancy map coordinate encoder encodes vertex occupancy map coordinates in the same order as the encoding of connection information.

The auxiliary information encoder encodes auxiliary information, such as patch information generated through projection.

The connection information encoder receives connection information between vertices as input and generates a connection information bitstream.

The connection information may be modified to reconstructed geometry information as input.

The texture coordinate encoder may encode the coordinates of a texture.

The vertex normal information encoder generates a vertex normal information bitstream based on the vertex normal information as input.

In some embodiments, a residual signal, which is the difference between the original and predicted normals, may be transmitted by performing a prediction based on the reconstructed normal information, which is a restoration of the previously encoded normal information, and/or the reconstructed geometry information.

In some embodiments, the normal information may be projected and packed in the same manner as the geometry information to generate a two- or three-channel image, which may be encoded using a 2D video encoder.

According to embodiments, the encoding may be performed on a per group of frame (GOF) basis.

Mesh data may be efficiently encoded, as illustrated in FIG. 22.

FIG. 23 illustrates a mesh data encoder having a color per vertex as color information according to embodiments

The mesh data encoder of FIG. 23 may be included in and correspond to the transmission device 1000, point cloud video encoder 10002, file/segment encapsulator 10003, transmitter 10004 of FIG. 1, the encoder of FIG. 4, the encoder of FIG. 15, the transmission device of FIG. 18, the XR device 2030 of FIG. 20, the mesh encoder of FIG. 22, the connection information encoder of FIG. 24, and the texture map encoder of FIG. 25, the vertex texture coordinate encoder of FIG. 26, the vertex texture encoder of FIG. 27, the normal information encoder of FIG. 28, the normal information encoder of FIG. 29, the auxiliary information encoder, depth image encoder, occupancy map coordinate encoder of FIG. 30, the occupancy map coordinate information encoder of FIG. 32, the point cloud data transmission method of FIG. 48, and the like. Each of the components of FIG. 23 may correspond to hardware, software, a processor, and/or a combination thereof.

FIG. 23 is a mesh data encoder having a color (category 2) per vertex as color information.

The vertex depth image may be composed of a 2D image representing the distance information between the vertex and the projection plane.

The vertex occupancy map coordinates are 2D coordinate information about occupied pixels in the occupancy map.

Mesh data having a color per vertex as color information may include vertex geometry information, vertex color information, connection information, and/or normal information.

Vertex position information (x,y,z) related to the mesh data may be divided into depth image, which represents the distance of the corresponding pixel from the projection plane in projection into a 2D image, and vertex occupancy map coordinates, which are the coordinate information in the occupancy map generated by projection and packing.

The depth image encoder encodes the depth image through a 2D video encoder.

The vertex occupancy map coordinate encoder encodes vertex occupancy map coordinates in the same order as the encoding of connection information.

The color information encoder receives vertex color information (R, G, B, etc.) and generates a bitstream for the vertex color information.

As for the color information, the color information related to the 3D mesh data is projected into a 2D image, and an image with color values may be encoded through the 2D video encoder.

The auxiliary information encoder encodes auxiliary information, such as patch information generated through projection.

The connection information encoder receives connection information between vertices in the mesh data as input and generates a connection information bitstream.

The vertex normal information encoder generates a vertex normal information bitstream based on the vertex normal information as input.

In some embodiments, a residual signal, which is the difference between the original and predicted normals, may be transmitted by performing a prediction based on the reconstructed normal information, which is a restoration of the previously encoded normal information, and/or the reconstructed geometry information.

In some embodiments, the normal information may be projected and packed in the same manner as the geometry information to generate a two- or three-channel image, which may be encoded using a 2D video encoder.

According to embodiments, the encoding may be performed on a per group of frame (GOF) basis.

Hereinafter, FIGS. 22 and 23 and the operation of each component included in the corresponding encoder will be described.

Mesh data may be efficiently encoded, as illustrated in FIG. 23.

FIG. 24 illustrates a connection information encoder according to embodiments.

The connection information symbolizer (corresponding to the symbolization process of TFAN, edge breaker, etc.) performs the mapping of some or all vertices or edges to a single symbol depending on the connection relationship.

In some embodiments, a table of probability values for a specific connection relationship may be signaled as auxiliary information. The specific connection relationship may be the number of edges connected to the vertex currently being encoded (degree of edge) or the number of triangles connected to the current vertex (degree of triangle), for example.

The connection information entropy encoder may entropy encode the mapped symbols with Exponential Golomb or Variable Length Coding (VLC), Context-Adaptive Variable Length Coding (CAVLC), Context-Adaptive Binary Arithmetic Coding (CABAC), or the like, according to embodiments.

FIG. 25 illustrates a texture map encoder according to embodiments.

The texture map is encoded by a 2D video encoder.

The color space of the texture map may be transformed by a color space transformer.

According to an embodiment, the color space may be transformed to a color space such as YUV, YCoCg, or the like. When the input texture map is in a 4:4:4 format, it may be transformed to a 4:2:0 format.

In some embodiments, the color space transformer may be omitted.

In some embodiments, when encoding dynamic mesh data that changes over time, texture map re-sorting may be performed to re-sort texture maps in specific units (such as GoFs) to be temporally similar to improve 2D video encoding performance.

When texture map re-sorting is performed, the texture coordinates and the texture coordinate index of the connection information may be modified according to the re-sorted texture map.

FIG. 26 illustrates a vertex texture coordinate encoder according to embodiments.

According to embodiments, vertex texture coordinates may be encoded in the same order as the encoding order of connection information.

In embodiment 1 of the vertex texture coordinate encoder, the encoding is performed in the same order as the encoding order of the connection information.

When the texture coordinates are real numbers, quantization to an integer with n-bit precision may be performed by a texture coordinate integerizer.

In some embodiments, the texture coordinate integerizer may be omitted if the texture coordinates are integers.

Once the texture coordinates are quantized to integers by the integerizer, a prediction of the current texture coordinates may be performed based on the one or more previously encoded texture coordinates, and a residual signal may be generated with the prediction signal removed.

According to embodiments, the prediction may be a difference prediction from a previous value, a parallelogram prediction, or the like.

The residual signal may be quantized by a quantizer and entropy encoded to generate a texture coordinate bitstream.

In some embodiments, the residual texture coordinate quantizer and the residual texture coordinate dequantizer may be omitted.

According to embodiments, the entropy encoder may perform entropy encoding using Exponential Golomb or Variable Length Coding (VLC), Context-Adaptive Variable Length Coding (CAVLC), Context-Adaptive Binary Arithmetic Coding (CABAC), or the like.

FIG. 27 illustrates a vertex texture coordinate encoder according to embodiments.

The encoder of FIG. 27 may correspond to the encoder of FIG. 26.

According to an embodiment, the vertex texture coordinates may be encoded by the 2D video encoder after a texture coordinate image is generated through projection and packing.

In Embodiment 2 of the vertex texture coordinate encoder, the encoding is performed by the 2D video encoder.

A 3D patch generator may receive vertex geometry information, vertex color information, normal information, and/or connection information as input and segment the vertex into multiple 3D patches based on the information. For each of the segmented 3D patches, an optimal projection plane may be determined based on the geometry, normal information, and/or color information.

A patch packer (patch packing) determines positions where the patches determined by the 3D patch generator are to be packed in a W×H image space without overlapping each other. In some embodiments, each patch may be packed such that when the W×H image space is partitioned into an M×N grid, only one patch is present in the M×N space.

The patch packer generates a two-channel 2D image. Here, the channels represent the u and v channels of the texture coordinates.

A texture coordinate image quantizer quantizes each pixel value of the texture coordinate image generated by the patch packer to an n-bit integer.

According to an embodiment, the texture coordinate integerizer may be omitted if the texture coordinates are integers.

A texture coordinate image padder performs padding on unoccupied pixel values in the 2D image with neighboring pixels based on an occupancy map or occupancy map coordinates as input.

FIG. 28 illustrates a normal information encoder according to embodiments.

The encoding order of the normal information may be determined by the same order as the encoding order of the reconstructed connection information or by a predetermined scanning order based on the reconstructed geometry information.—Embodiment 1

According to an embodiment, the normal information may be transformed to spherical coordinates or octahedron coordinates by a coordinate transformer.

In the case where the normal information is a real number, quantization to an integer with n-bit precision may be performed by the texture coordinate integerizer.

According to an embodiment, the texture coordinate integerizer may be omitted if the normal information is an integer.

For the normal information, prediction of the current vertex normal information may be performed based on the reconstructed geometry information and/or the reconstructed neighboring vertex normal information.

According to an embodiment, residual normal information, which is a residual from the original normal information, may be quantized by a residual normal information quantizer.

The residual normal information may be entropy encoded by a normal information entropy encoder to generate a bitstream.

According to an embodiment, the quantized residual normal information or quantized normal information may be entropy encoded by an entropy encoder using Exponential Golomb, Variable Length Coding (VLC), Context-Adaptive Variable Length Coding (CAVLC), Context-Adaptive Binary Arithmetic Coding (CABAC), or the like.

FIG. 29 illustrates a normal information encoder according to embodiments.

The encoder of FIG. 29 may correspond to the encoder of FIG. 28.

According to an embodiment, the vertex normal coordinates may be encoded by the 2D video encoder after a normal image is generated through projection and packing.—Embodiment 2

In this case, the pixel values of the normal image mean normal coordinates, and the normal information may be composed of a two- or three-channel image.

According to an embodiment, the normal information may be transformed to spherical coordinates or octahedron coordinates by a coordinate transformer.

A 3D patch generator (3D patch generation) may receive vertex geometry information, vertex color information, normal information, and/or connection information as input and segment the vertex into multiple 3D patches based on the information. For each of the segmented 3D patches, an optimal projection plane may be determined based on the geometry, normal information, and/or color information.

A patch packer (patch packing) determines positions where the patches determined by the 3D patch generator are to be packed in a W×H image space without overlapping each other. In some embodiments, each patch may be packed such that when the W×H image space is partitioned into an M×N grid, only one patch is present in the M×N space.

A three-channel or two-channel normal image may be generated by the patch packer.

According to an embodiment, in the three-channel image, each of the channel pixel values represents a normal vector value along the x, y, or z axis.

According to an embodiment, in the two-channel image, each of the channels represents a normal coordinate value in a spherical coordinate system or an octahedral coordinate system obtained by transformation by the normal information coordinate transformer.

The normal image quantizer quantizes each pixel value of the normal image generated by the patch packer into an n-bit integer.

According to an embodiment, the texture coordinate integerizer may be omitted if the texture coordinates are integers.

A normal image padder performs padding on unoccupied pixel values in the 2D image with neighboring pixels based on an occupancy map or occupancy map coordinates as input.

FIG. 30 illustrates auxiliary information, depth image, and occupancy map coordinate encoders according to embodiments.

A 3D patch generator may receive vertex geometry information, vertex color information, normal information, and/or connection information as input and segment the vertex into multiple 3D patches based on the information. For each of the segmented 3D patches, an optimal projection plane may be determined based on the geometry, normal information, and/or color information.

A patch packer determines positions where the patches determined by the 3D patch generator are to be packed in a W×H image space without overlapping each other. In some embodiments, each patch may be packed such that when the W×H image space is partitioned into a grid, only one patch is present in the M×N space.

The auxiliary information encoder may encode a projection plane index determined per patch, a 2D bounding box position (u0,v0,u1,v1) of the corresponding patch, and/or a 3D reconstructed position (x0,y0,z0) based on the bounding box of the patch, and/or a Pw×Ph unit patch index map in the W H image space.

The depth image generator generates a single channel image of the distance of each vertex to the projection plane based on the patch information generated by the patch packer.

According to an embodiment, M depth images may be generated for cases where multiple points are projected onto a single pixel.

When the depth images are generated, each depth image may include depth values where the pixel value is N-th (1<=n<=m) closest to the projection plane.

A depth image sampler may perform down-sampling by m×n units for encoding.

The down-sampling may be performed by down-sampling the pixel values (depth information) present in a m×n block to a single pixel value.

Down-sampling may be performed using methods such as average, weighted average, median, etc.

When down-sampling is performed in m×n units, a depth image with size w×h is encoded in size w/m×h/n.

Here, m and n may be determined by the agreement between the encoder/decoder, or may be input as encoding parameters and signaled on a per sequence, frame, slice, or the like basis, or may be derived based on the occupancy map coordinates and depth image generated by the encoder.

According to an embodiment, only one value may be signaled when m=n at all times.

According to an embodiment, when two or more depth images are encoded, each depth image may be down-sampled by a different unit.

In this case, the mi and ni of each depth image may be signaled through auxiliary information or may be determined by the agreement between the encoder/decoder.

The geometry image padder may perform the process of filling in the image values of the parts of the image where vertices are not present based on the occupancy map with the distance values to the projection plane of the neighboring vertices.

The padded geometry may be encoded by the 2D video encoder.

In embodiments, the mapping table does not need to be transmitted. In other words, the mapping table may have a dynamic range of (0 to N−1, where N=number of vertices), which may result in a large bit count. Therefore, in some embodiments, when occupancy map coordinates (u,v) are transmitted, the dynamic range of the coordinates (u,v) is determined by the size (W, H) of the corresponding patch (0≤u<W, 0≤v<H). Furthermore, for the coordinates u and v, the spatial redundancy is large, and thus the encoding may be performed more effectively than when transmitting a mapping table.

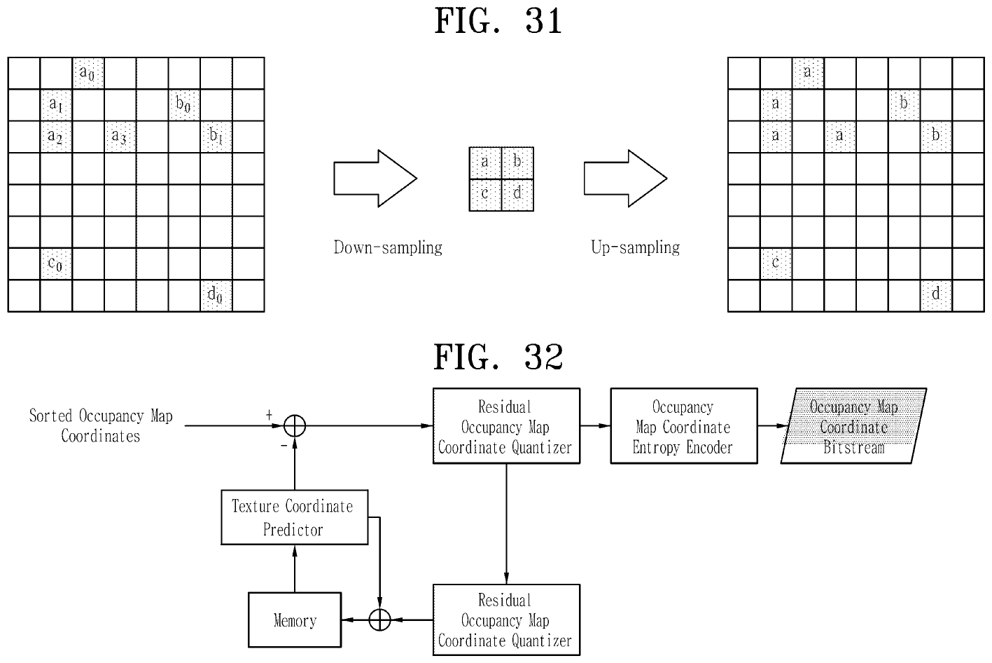

FIG. 31 illustrates an example of depth image down-sampling (encoder) and up-sampling (decoder) according to embodiments.

FIG. 31 illustrates an example of down-sampling and up-sampling when m and n are 4.

An occupancy map coordinate generator may generate an occupancy map based on the presence or absence of projected points in the 2D image space. The coordinates (u,v) in the 2D image space of the generated occupancy map may be generated as occupancy map coordinates.

In the process of packing 3D patches into 2D images by the patch packer, it may be determined whether a vertex is present in the 2D image space.

in the case where multiple depth images are generated by the depth image generator, an occupancy map may be generated for each depth image to generate occupancy map coordinates from the occupancy maps.

An occupancy map coordinate sorter sorts the occupancy map coordinates in order of the original vertex position information.

In this regard, the sorting may be performed by calculating the mapping relationship between the original vertex position information and the projected pixels.

The mapping relationship may be calculated based on the original vertex position information, the position information obtained by reconstructing the projected pixels into a three-dimensional space, and/or color information.

According to an embodiment, the mapping relationship may be calculated based on the reconstructed depth image, the reconstructed occupancy map coordinates, and/or the reconstructed vertex color information.

To generate, sort, and encode the occupancy map coordinates, the method/device according to the embodiments may generate 3D patches from the vertex positions or vertex geometry of the mesh data and pack the patches.

Regarding the down-sampling, only values for which pixels (depth images) are present are left in the block unit. For example, the median (or average) of a0 to a3 may be a after down-sampling. In other words, when the mesh data is sparse, the number of vertices occupying the m×n block may be small, and thus they may be effectively encoded/decoded.

FIG. 32 illustrates an occupancy map coordinate information encoder according to embodiments.

The occupancy map coordinate encoder encodes the occupancy map coordinates sorted in order of the original vertex position information in the same order as the encoding order of the connection information.

For the occupancy map coordinates, the current occupancy map coordinates may be predicted from one or more previously encoded occupancy map coordinates.

According to an embodiment, the prediction may include a prediction of a difference from a previous value and a parallelogram prediction.

The residual signal, which is a result of subtracting the predicted signal from the original signal, may be quantized by a quantizer.

According to an embodiment, the residual texture coordinate quantizer and dequantizer may be omitted.

The quantized residual coordinates or residual coordinates may be entropy encoded to generate a texture coordinate bitstream.

According to an embodiment, the entropy encoder may perform the entropy encoding using Exponential Golomb or Variable Length Coding (VLC), Context-Adaptive Variable Length Coding (CAVLC), Context-Adaptive Binary Arithmetic Coding (CABAC), or the like.

Hereinafter, a reception device and a method for the reception device according to embodiments will be described.

The reception device and method for the reception device may perform processes corresponding to the transmission device and method for the transmission device and/or reverse processes.

FIG. 33 illustrates a mesh data decoder having a texture map as color information according to embodiments.

A texture map decoder reconstructs the input texture map through a 2D video decoder to generate a reconstructed texture map.

The auxiliary information decoder decodes an input auxiliary information bitstream to reconstruct auxiliary information for reconstructing the projected geometry and color images into a three-dimensional mesh.

According to an embodiment, the auxiliary information may include a projection plane index determined per patch, a 2D bounding box position (u0,v0,u1,v1) of the corresponding patch, a 3D reconstructed position (x0,y0,z0) based on the bounding box of the patch, and/or a patch index map in M×N units in the W×H image space.

The depth image decoder reconstructs the depth image through a 2D video decoder.

The vertex occupancy map coordinate decoder decodes the vertex occupancy map coordinates in the same order as the decoding of the connection information.

The vertex position information reconstructor reconstructs the vertex position information from the reconstructed depth image and occupancy map coordinates.

The normal information decoder reconstructs the vertex normal information from the normal information bitstream.

According to an embodiment, the vertex normal information may be reconstructed by reconstructing residual normal information and adding the same to the predicted normal information generated by performing a prediction based on the reconstructed normal information obtained by reconstructing the previously decoded normal information, and/or the reconstructed geometry.

According to an embodiment, the normal information may be projected and packed in the same way as the geometry information to generate a two- or three-channel image. When the image is encoded by the 2D video encoder, a normal image may be reconstructed by the 2D video decoder, and the vertex normal information may be reconstructed by the auxiliary information.

The texture coordinate decoder reconstructs per-vertex texture coordinates based on the texture coordinate bitstream as input.

According to an embodiment, residual texture coordinates may be reconstructed and vertex texture coordinates may be reconstructed by adding the same to the predicted texture coordinates generated by performing a prediction based on the previously decoded texture coordinates.

According to an embodiment, when the texture coordinates are projected and packed in the same manner as the geometry information to generate a two-channel image and the image is encoded through a 2D video encoder, the texture coordinate image may be reconstructed through a 2D video decoder, and the vertex texture coordinates may be reconstructed based on the auxiliary information.

The connection information decoder decodes the connection information bitstream to reconstruct the connection information between the vertices.

According to an embodiment, 2D video decoding of the texture map and depth image information may be performed on a per group of frame (GOF) basis.

Accordingly, the connection information, auxiliary information, and normal information may be decoded on a per GOF basis.

FIG. 34 illustrates a mesh data decoder having a color per vertex as color information according to embodiments.

The auxiliary information decoder decodes the input auxiliary information bitstream to reconstruct auxiliary information for reconstructing a 3D mesh from the projected geometry and color image.

The vertex color image decoder receives a vertex color image bitstream as input and reconstructs the color image using a 2D video decoder.

The depth image decoder reconstructs a depth image using the 2D video decoder.

The vertex occupancy map coordinate decoder decodes the vertex occupancy map coordinates in the same order as the decoding of the connection information.

The vertex position information reconstructor reconstructs the vertex position information based on the reconstructed depth image and occupancy map coordinates.

The vertex color information reconstructor reconstructs the color of the vertex based on the reconstructed vertex position information and auxiliary information as input.

The normal information decoder reconstructs the vertex normal information from the normal information bitstream.

According to an embodiment, the vertex normal information may be reconstructed by reconstructing residual normal information and adding the same to the predicted normal information generated by performing a prediction based on the reconstructed normal information obtained by reconstructing the previously decoded normal information, and/or the reconstructed geometry.

According to an embodiment, the normal information may be projected and packed in the same way as the geometry information to generate a two- or three-channel image. When the image is encoded by the 2D video encoder, a normal image may be reconstructed by the 2D video decoder, and the vertex normal information may be reconstructed by the auxiliary information.

The connection information decoder decodes the connection information bitstream to reconstruct the connection information between the vertices.

According to an embodiment, 2D video decoding of the texture map and depth image information may be performed on a per group of frame (GOF) basis.

Accordingly, the connection information, auxiliary information, and normal information may be decoded on a per GOF basis.

FIG. 35 illustrates a connection information decoder according to embodiments.

The connection information entropy decoder may entropy encode the mapped symbols with Exponential Golomb or Variable Length Coding (VLC), Context-Adaptive Variable Length Coding (CAVLC), Context-Adaptive Binary Arithmetic Coding (CABAC), or the like, according to embodiments.

According to an embodiment, the entropy probability values of the connection information entropy decoder may be initialized on a per frame, per subunit of a frame, or per GOF basis.

Further, according to an embodiment, a table of probability values in a specific connection may be used as input to the connection information entropy decoder for entropy decoding. In this case, the specific connection may be the number of edges connected to the vertex currently being decoded, or the number of triangles connected to the current vertex, or the like.

The connection information reconstructor reconstructs the connection information from the symbols representing the connection of the vertices or edges decoded by the entropy decoder.

FIG. 36 illustrates a normal information decoder according to embodiments.

The normal information may be decoded in the same order as the reconstructed connection information is encoded.—Embodiment 1

The normal information decoder receives a parsed normal information bitstream and performs entropy decoding and dequantization to generate reconstructed residual normal information.

The entropy decoding may be performed using Exponential Golomb or Variable Length Coding (VLC), Context-Adaptive Variable Length Coding (CAVLC), Context-Adaptive Binary Arithmetic Coding (CABAC), or the like.

Reconstructed normal information may be generated by adding the predicted normal information and the reconstructed residual normal information.

The normal information predictor may predict the current vertex normal information based on the pre-reconstructed normal information and/or the reconstructed geometry information.

According to an embodiment, the prediction may be a prediction of a difference from a previous value, a parallelogram prediction, or the like.

According to an embodiment, the normal information generated by adding the residual signal and the prediction signal may be dequantized to a real number by a dequantizer.

According to an embodiment, in the case where the normal information has been transformed to spherical coordinates or octahedron coordinates by the coordinate transformer and encoded, a coordinate inverse transformation may be performed.

According to an embodiment, the normal information coordinate inverse transformation may be performed after the normal information dequantization is performed.

FIG. 37 illustrates a normal information decoder according to embodiments.

According to an embodiment, vertex normal coordinates may be reconstructed by parsing a normal image generated through projection and packing.—Embodiment 2

A reconstructed normal image is generated by a 2D video decoder based on the normal information bitstream as input.

According to an embodiment, the normal image may be composed of two channels or three channels.

The vertex normal information may be reconstructed based on the reconstructed normal image, occupancy coordinate map, auxiliary information, and reconstructed position information.

According to an embodiment, in the case where the normal information has been transformed to spherical coordinates or octahedron coordinates by a coordinate transformer and encoded, a coordinate inverse transformation may be performed.

Whether the coordinate transformation has been performed may be determined by parsing a 1-bit flag or coordinate transformation index.

According to an embodiment, the normal information coordinate inverse transformation may be performed after the normal information dequantization is performed.

According to an embodiment, the normal information generated by adding the residual signal and the prediction signal may be dequantized to a real number by the dequantizer.

FIG. 38 illustrates a texture coordinate decoder according to embodiments.

The texture coordinate decoding may be performed in the same order as the encoding order of the reconstructed connection information.—Embodiment 1

The texture coordinate decoder receives a parsed texture coordinate bitstream and performs entropy decoding and dequantization to generate reconstructed residual texture coordinates.

The entropy decoding may be performed using Exponential Golomb or Variable Length Coding (VLC), Context-Adaptive Variable Length Coding (CAVLC), Context-Adaptive Binary Arithmetic Coding (CABAC), or the like.

Reconstructed texture coordinates may be generated by adding the predicted texture coordinates and the reconstructed residual texture coordinates.

The texture coordinate predictor may predict the current vertex texture coordinates based on the pre-reconstructed texture coordinates.

According to an embodiment, the prediction may be a prediction of a difference from a previous value, a parallelogram prediction, or the like.

According to an embodiment, the texture coordinates generated by adding the residual signal and the prediction signal may be dequantized to a real number by a dequantizer.

FIG. 39 illustrates a texture coordinate decoder according to embodiments.

According to an embodiment, vertex texture coordinates may be reconstructed by parsing a normal image generated through projection and packing.—Embodiment 2

A reconstructed two-channel texture coordinate image is generated by a 2D video decoder based on the texture coordinate bitstream as input.

The vertex texture coordinates may be reconstructed based on the reconstructed texture coordinate image, occupancy coordinate map, auxiliary information, and reconstructed position information.

According to an embodiment, the texture coordinates generated by adding the residual signal and the prediction signal may be dequantized to a real number by the dequantizer.

FIG. 40 illustrates an auxiliary information decoder and a position information decoder according to embodiments.

The auxiliary information decoder decodes the input auxiliary information bitstream to reconstruct auxiliary information for reconstructing a 3D mesh from the projected geometry and color image.

According to an embodiment, the auxiliary information may include a projection plane index determined per patch, a 2D bounding box position (s0,t0,s1,t1) of the corresponding patch, a 3D reconstructed position (x0,y0,z0) based on the bounding box of the patch, and/or a patch index map in Pw×Ph units in the W×H image space.

The three-dimensional (x,y,z) reconstruction is performed by a position information reconstructor based on the reconstructed depth image, reconstructed occupancy map coordinates, and auxiliary information obtained by decoding the geometry image and occupancy map coordinates generated by the encoder. In the case of depth image up-sampling, the reconstructed depth image may be up-sampled by the up-sampling part of the 2D video decoder. Alternatively, a separate up-sampling process may not be performed, and the depth information corresponding to each occupancy map coordinate may be derived by the position information reconstructor through the following operation of the position information reconstructor.

FIG. 41 illustrates an occupancy map coordinate decoder according to embodiments.

The occupancy map coordinate decoder receives a parsed occupancy map coordinate bitstream, generates reconstructed residual occupancy map coordinates by performing entropy decoding and dequantization, and reconstructs the occupancy map coordinates by adding the predicted values generated by the predictor.

According to an embodiment, the residual occupancy map coordinate dequantizer may be omitted.

The entropy decoding may be performed using Exponential Golomb or Variable Length Coding (VLC), Context-Adaptive Variable Length Coding (CAVLC), Context-Adaptive Binary Arithmetic Coding (CABAC), or the like.

The reconstructed occupancy map coordinates may be generated by adding the predicted occupancy map coordinates and the reconstructed residual occupancy map coordinates.

The occupancy map coordinate predictor may predict the current occupancy map coordinates based on the reconstructed occupancy map coordinates.

According to an embodiment, the prediction may be a prediction of a difference from a previous value, a parallelogram prediction, or the like.

According to an embodiment, the occupancy map coordinates generated by adding the residual signal and the prediction signal may be dequantized to real numbers by a dequantizer.

According to an embodiment, the patch index corresponding to the occupancy map coordinates may be encoded/decoded in the same order as the encoding/decoding order of the occupancy map coordinates.

In the case where a patch index is encoded/decoded per occupancy map coordinate, encoding/decoding of the patch index map is skipped.

When a patch index is encoded/decoded per occupancy map coordinate, (Pidx, u, v) is encoded/decoded in the same order as the connection information.

For patch indexes corresponding to occupancy map coordinates, prediction may be performed based on the reconstructed patch index values of the previous turn.

The prediction may be a prediction of a difference from the previously reconstructed patch index, or the like.

According to an embodiment, in predicting the occupancy map coordinates, the prediction may be performed solely based on the occupancy map coordinates where the patch index of the previously reconstructed occupancy map coordinate is the same as the patch index of the occupancy map coordinate to be reconstructed.

When the patch index of the current occupancy map coordinate is different from the patch index of the immediately preceding reconstructed occupancy map coordinate, the prediction may not be performed, or the current occupancy map coordinate may be predicted as the value with the most similar reconstruction order among the pre-reconstructed occupancy coordinates having the same patch index as the current occupancy map coordinate.

FIG. 42 illustrates a patch index map and coordinates of a 2D bounding box of a patch according to embodiments.

When the patch index is encoded/decoded per occupancy map coordinate, (Pidx, u, v) is encoded/decoded for each vertex in the same order as the connection information.

According to an embodiment, for the occupancy map coordinates, the delta occupancy coordinates calculated through the bounding box of the current patch may be encoded/decoded. (Pidx, δu, δv)

According to an embodiment, the delta occupancy coordinates may be calculated and encoded using the following equations based on the 2D bounding box coordinates of the corresponding patch. (Encoder)

(sᵢ₀, tᵢ₀): The coordinates of the top-left corner of the i-th patch

(sᵢ₁, tᵢ₁): The coordinates of the bottom-right corner of the i-th patch

$$δ u = u - {s}_{i 0} , δ v = v - {t}_{i 0} \qquad ( Example equation 1 )$$

$$δ u = {s}_{i 1} - u , δ v = {t}_{i 1} - v \qquad ( Example equation 2 )$$

The occupancy map coordinates may be reconstructed from the parsed patch index and delta occupancy coordinates using the following example equations. (Decoder)

$$u = {s}_{i 0} + δ u , v = {t}_{i 0} + δ v \qquad ( Example equation 1 )$$

$$u = {s}_{i 1} - δ u , v = {t}_{i 1} - δ v \qquad ( Example equation 2 )$$

According to an embodiment, the patch index and delta occupancy map coordinates may be predicted based on the previously decoded patch index and delta occupancy coordinates.

The depth image decoder reconstructs a depth image through a 2D video decoder based on the depth image bitstream as input.

According to an embodiment, the depth image decoder may not generate an up-sampled depth image, but may reconstruct the depth image using a position information reconstructor on a vertex-by-vertex basis based on the reconstructed occupancy map coordinates and the decoded

$$\frac{w}{m} \times \frac{h}{n}$$

depth image as input.

Whether the decoded depth image is down-sampled may be determined by the decoder by parsing a 1-bit flag (isDownsampled).

The depth value corresponding to the reconstructed occupancy map coordinates (uᵢ, vᵢ) may be decoded to the pixel values of

$$( \frac{{u}_{i}}{scaleM} , \frac{{v}_{i}}{scaleN} )$$

of the decoded depth image.

The scale parameters scaleM and scaleN may be determined by the agreement between the encoder/decoder or may be parsed and determined.

According to an embodiment, only one value may be parsed if scaleM=scaleN at all times.

According to an embodiment, when two or more depth images are down-sampled to different sizes and encoded, the depth values may be reconstructed by parsing scaleMᵢ,scaleNᵢ of each depth image or by scaleMᵢ,scaleNᵢ defined by an agreement between the encoder/decoder.

According to an embodiment, the scale parameter isDownsampled may be parsed on a per sequence, group of frames (GoF), or frame basis.

For example, in some embodiments, the occupancy map coordinates may be reconstructed by parsing the patch index map and (u,v) coordinates. Also, the occupancy map coordinates may be reconstructed by receiving (p_idx,v) per vertex.

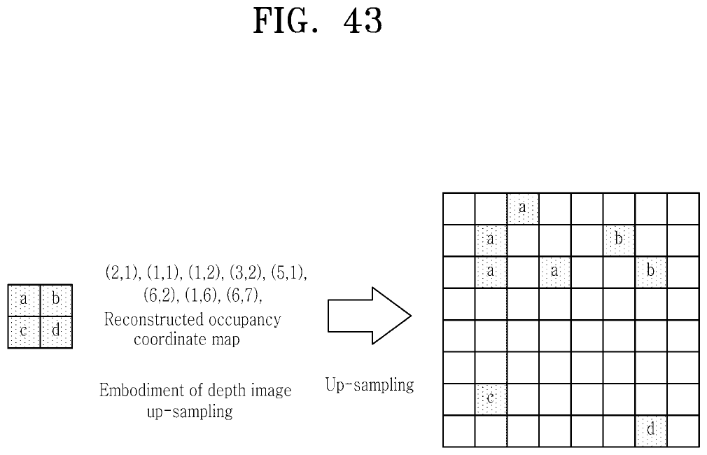

FIG. 43 illustrates an example of depth image up-sampling according to embodiments.

The position information reconstructor reconstructs the position information about a vertex based on the depth image reconstructed by the depth image decoder, the occupancy map coordinates reconstructed by the occupancy map coordinate decoder, and auxiliary information as input.

(uᵢ, vᵢ, dᵢ) may be generated by adding the depth value, which is the pixel value of the depth image of the position, to the reconstructed occupancy map coordinates (uᵢ, vᵢ), and 3D position information may be calculated based on the auxiliary information (x_{off}, y_{off}, z_{off}) corresponding to (uᵢ, vᵢ).

The offset values added to (uᵢ, vᵢ, dᵢ) may be determined by the projection plane corresponding to the position (uᵢ, vᵢ).

According to an embodiment, when multiple reconstructed occupancy map coordinates are the same, the depth information corresponding to each occupancy map coordinate may be mapped by the following methods.

Embodiment 1) A plurality of depth images may be reconstructed and the depth information may be mapped in the order promised by the encoder/decoder.

When occupancy map coordinates having the same coordinate are reconstructed, the reconstruction may be performed by mapping the coordinates to the depth information corresponding to the current occupancy map coordinates in descending order or ascending order of depth values.

Embodiment 2) Reconstruction may be performed by reconstructing multiple depth images and mapping the depth information by parsing the depth image index for the same occupancy map coordinate.

Embodiment 3) Reconstruction may be performed by parsing depth information based on auxiliary information in the same order as the reconstruction order of occupancy map coordinates having the same coordinate value and mapping the depth information.

Embodiment 4) The encoder may pack information into an empty region in the depth image in the order determined by the encoder/decoder, and the depth information may be parsed and accessed in the order determined by the encoder/decoder to map the depth information and perform reconstruction.

In this case, the starting position coordinates of the corresponding region in the depth image may be parsed and determined.

Here, the order determined by the encoder/decoder may be a z-scan order, or the like.

In order to add/execute embodiments, relevant information may be signaled. The signaling information according to the embodiments may be used at the transmitting side or the receiving side. The signaling information according to the embodiments may be generated and transmitted by a transmission device according to the embodiments, for example, the metadata processor (which may be referred to as a metadata generator, or the like) of the transmission device, and received and acquired by the metadata parser of the reception device. Each operation of the reception device according to the embodiments may be performed based on the signaling information.

Hereinafter, the signaling information in the bitstream and the syntax of the position information reconstructor related to the embodiments are described.

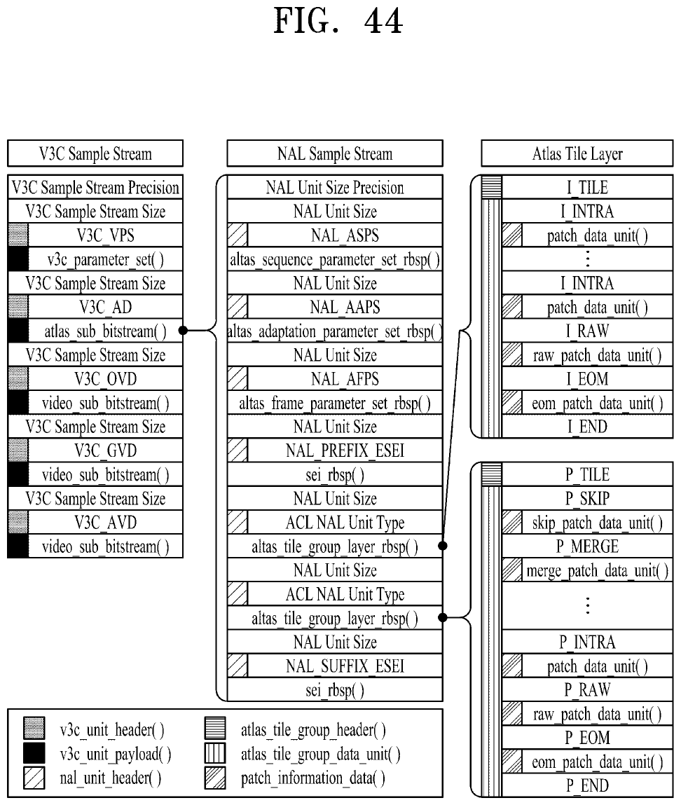

FIG. 44 illustrates a bitstream according to embodiments.

A point cloud data transmission method/device according to embodiments may compress (encode) point cloud data, generate related parameter information, and generate and transmit a bitstream as shown in FIG. 44.

A point cloud data reception method/device according to embodiments may receive a bitstream as shown in FIG. 26 and decode point cloud data contained in the bitstream based on parameter information contained in the bitstream.

In the point cloud data transmission device according to the embodiments, the signaling information (which may be referred to as parameters/metadata, etc.) may be encoded by a metadata encoding unit (which may be referred to as a metadata encoder or the like) and transmitted in the bitstream. Further, in the point cloud data reception device according to embodiments, it may be decoded by a metadata decoding unit (which may be referred to as a metadata decoder or the like) and provided to a decoding process of the point cloud data.

According to embodiments, the transmitter may encode the point cloud data to generate a bitstream.

According to embodiments, the bitstream may include a V3C unit.

According to embodiments, the receiver may receive the bitstream transmitted by the transmitter, decode and reconstruct the point cloud data. Specific syntax of the V3C unit according to the embodiments and elements included in the V3C unit are described below.

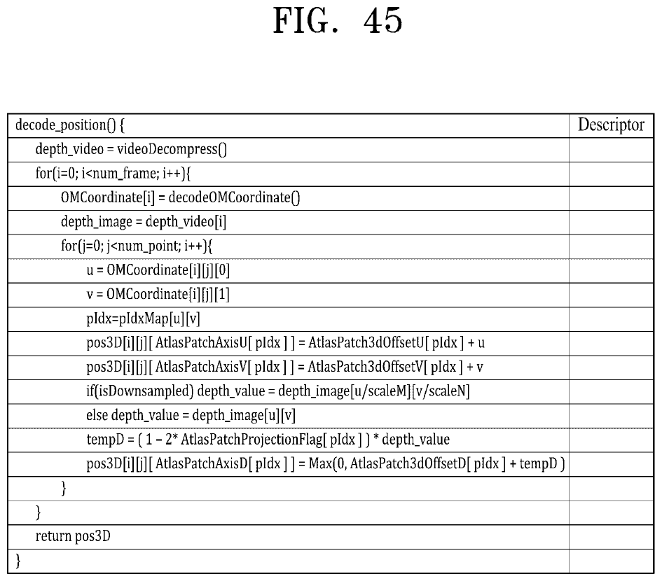

FIG. 45 illustrates decode position information according to embodiments.

FIG. 45 illustrates the information contained in the bitstream of FIG. 44.

AtlasPatchAxisU[p] is the tangent index to the projection plane of the current patch with patch index p. The value of AtlasPatchAxisU[p] may be in the range of 0 to 2.

AtlasPatchAxisV[p] is the index in both directions with respect to the projection plane for the current patch with patch index p. The value of AtlasPatchAxisV[p] may be in the range of 0 to 2.

AtlasPatchAxisD[p] is the normal index to the projection plane for the current patch with patch index p. The value of AtlasPatchAxisD[p] may be in the range of 0 to 2.

AtlasPatchProjectionFlag[p] indicates that the current patch with patch index p should be projected onto one of the two projection planes denoted by the AtlasPatchProjectionFlag[p] plane.
OMCoordinate[i][j]: Indicates the j-th occupancy map coordinate value in the i-th frame. For example, OMCoordinate[0] indicates u, and OMCoordinate[1] indicates v.

Down-sampling information (isDownsampled): A flag indicating whether the depth image is down-sampled. For example, 0: Not down-sampled (X), 1: downsampled (O).
pIdxMap: Indicates the patch index map.
pos3D[i][j]: Indicates the position information (x, y, z) about the j-th 3D vertex of the i-th frame.
scaleM: Width-axis down-sampling scale parameter of the depth image.
scaleN: Height-axis down-sampling scale parameter of the depth image.

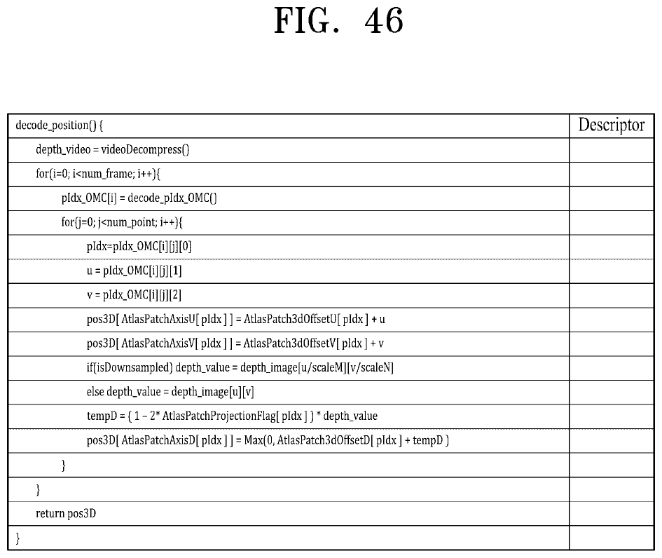

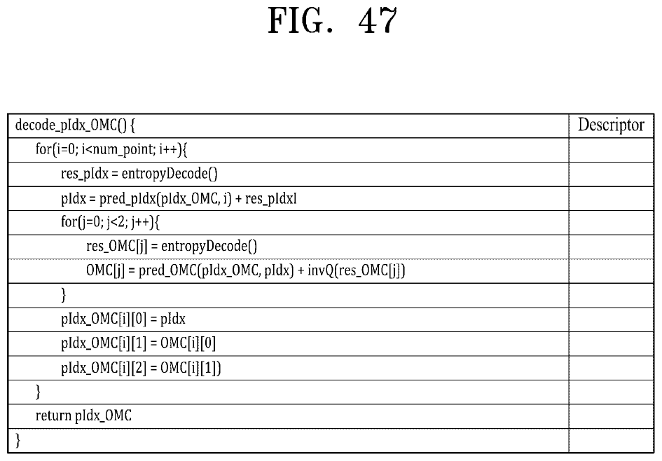

FIGS. 46 and 47 illustrate decode position and decode patch index occupancy map coordinates according to embodiments.

FIGS. 46 and 47 are included in the bitstream of FIG. 44.

When the occupancy map coordinates and patch index per vertex are parsed, the syntax of the position information reconstructor is given in FIGS. 46 and 47.
res_pIdx: Indicates the entropy decoded residual patch index of the current vertex.
pIdx: Indicates the patch index of the current vertex.
res_OMC: Indicates the entropy decoded residual occupancy map coordinates of the current vertex.
OMC: Indicates the reconstructed occupancy map coordinates (u,v) of the current vertex.
pIdx_OMC: Indicates the reconstructed patch index and reconstructed occupancy map coordinates (pIdx, u, v) of the current vertex.

FIG. 48 illustrates a method of transmitting point cloud data according to embodiments.

The point cloud data transmission method according to the embodiments may be performed by the point cloud data transmission device according to the embodiments: the transmission device 1000, point cloud video encoder 10002, file/segment encapsulator 10003, transmitter 10004 of FIG. 1, the encoder of FIG. 4, the encoder of FIG. 15, the transmission device of FIG. 18, the XR device 2030 of FIG. 20, the mesh encoder of FIG. 22, the connection information encoder of FIG. 24, and the texture map encoder of FIG. 25, the vertex texture coordinate encoder of FIG. 26, the vertex texture encoder of FIG. 27, the normal information encoder of FIG. 28, the normal information encoder of FIG. 29, the auxiliary information encoder, depth image encoder, occupancy map coordinate encoder of FIG. 30, the occupancy map coordinate information encoder of FIG. 32, and the like.

S4800: A point cloud data transmission method according to embodiments may include encoding point cloud data.

The encoding operation according to the embodiments may include the encoding operation of FIGS. 1 to 20, and the mesh data encoding operation of FIGS. 21 to 32. By performing the encoding, a bitstream of FIG. 44 or the like containing the encoded point cloud data and parameters may be generated.

S4801: The point cloud data transmission method according to the embodiments may further include transmitting a bitstream containing the point cloud data.

The transmission operation according to the embodiments may include the generation and transmission of a bitstream of FIGS. 1 to 20, the transmission of the encoded mesh data of FIGS. 21 to 32, and the transmission in the form of a bitstream of FIG. 44, etc.

FIG. 49 illustrates a point cloud data reception method according to embodiments.

The point cloud data reception method according to the embodiments may be performed by the point cloud data reception device according to the embodiments: the reception device 10005, point cloud video decoder 10008, file/segment decapsulator 10007, receiver 10006 of FIG. 1, the decoder of FIGS. 16 and 17, the reception device of FIG. 19, the XR device 2030 of FIG. 20, the mesh encoder of FIG. 23, the mesh data decoder of FIGS. 33 and 34, the connection information decoder of FIG. 35, the normal information decoder of FIG. 36, the normal information decoder of FIG. 37, the texture coordinate decoder of FIG. 38, the texture coordinate decoder of FIG. 39, the auxiliary information decoder and position information decoder of FIG. 40, the occupancy map coordinate decoder of FIG. 41, and the like.

S4900: The point cloud data reception method according to the embodiments may include receiving a bitstream containing point cloud data.

The receiving operation according to the embodiments may include receiving the bitstream of FIG. 44, and parsing the signaling information of FIGS. 45 to 47 contained in the bitstream.

S4901: The point cloud data reception method according to the embodiments may further include decoding the point cloud data.

The decoding operation according to the embodiments may include the decoding operation of FIGS. 1 to 20, and may include the mesh data decoding operation of FIGS. 33 to 43. The decoding operation according to the embodiments may be performed based on the signaling information of FIGS. 45 to 47.

Referring to FIG. 1, the transmission method according to the embodiments may include encoding point cloud data, and transmitting a bitstream containing the point cloud data.

Referring to FIG. 22, regarding encoding mesh data (color information=texture map), the encoding of the point cloud data may include encoding a mesh data of the point cloud data, wherein the encoding of the mesh data may include encoding a texture map, encoding auxiliary information, and encoding a vertex depth image, encoding vertex occupancy map coordinates, encoding connection information, encoding texture coordinates, and encoding vertex normal information. The encoding of the vertex occupancy map coordinates may include encoding the vertex occupancy map coordinates based on the order of the encoding the connection information.

Referring to FIG. 23, regarding the encoding of the mesh data (color information=color per vertex), the encoding of the point cloud data may include encoding mesh data of the point cloud data, wherein the encoding of the mesh data may include encoding vertex color information, and encoding auxiliary information, encoding a vertex depth image, encoding vertex occupancy map coordinates, encoding connection information, and encoding vertex normal information. The encoding of the vertex occupancy map coordinates may include encoding the vertex occupancy map coordinates based on the order of the encoding of the connection information.

Referring to FIG. 30, regarding the occupancy map coordinate encoder, the encoding of the vertex occupancy map coordinates may include generating the occupancy map coordinates, and sorting the occupancy map coordinates. The generating of the occupancy map coordinates may include generating an occupancy map from patches generated based on vertex position information related to the mesh data, generating the occupancy map coordinates based on the occupancy map, and sorting the occupancy map coordinates. The sorting of the occupancy map coordinates may include sorting the occupancy map coordinates based on the vertex position information, the sorted occupancy map coordinates being encoded in the same order as the encoding of the connection information, predicting the occupancy map coordinates, and generating a residual based on the occupancy map coordinates and the predicted occupancy map coordinates.

Referring to FIG. 30, regarding the encoding of the vertex depth image, the encoding of the vertex depth image may include generating a depth image from patches generated based on the vertex position information related to the mesh data, and down-sampling the depth image to one pixel.

The point cloud data transmission method may be carried out by a transmission device. The transmission device may include an encoder configured to encode point cloud data, and a transmitter configured to transmit a bitstream containing the point cloud data.

A reception method according to embodiments may include receiving a bitstream containing point cloud data; and decoding the point cloud data.

Referring to FIG. 33, regarding the mesh data decoder (color information=texture map), the decoding of the point cloud data may include decoding mesh data of the point cloud data. The decoding of the mesh data may include decoding a texture map, decoding auxiliary information, and decoding a vertex depth image, decoding vertex occupancy map coordinates, decoding connection information, decoding texture coordinates, and decoding vertex normal information. The decoding of the vertex occupancy map coordinates may include decoding the vertex occupancy map coordinates based on an order of the decoding of the connection information.

Referring to FIG. 34, regarding the mesh data decoder (color information=color per vertex), the decoding of the point cloud data may include decoding mesh data of the point cloud data, wherein the decoding of the mesh data may include decoding vertex color information, decoding auxiliary information, decoding auxiliary information, decoding a vertex depth image, decoding vertex occupancy map coordinates, decoding connection information, and decoding vertex normal information. The decoding of the vertex occupancy map coordinates may be performed based on the order of the decoding of the connection information.

Referring to FIGS. 40 and 41, regarding the vertex occupancy map coordinate decoder, the decoding of the vertex occupancy map coordinates may include decoding the occupancy map coordinates in the bitstream, generating a residual related to the vertex occupancy map coordinates by dequantization, generating a predicted value related to the vertex occupancy map, reconstructing occupancy map coordinates, and decoding a patch index related to the occupancy map coordinates based on the order of the reconstruction of the vertex occupancy map coordinates.

Referring to FIG. 42, regarding the vertex occupancy map coordinate decoder, a patch index may be predicted based on a value of the previously reconstructed patch index.

Referring to FIG. 43, regarding the depth image decoding, the decoding of the vertex depth image may include decoding the vertex depth image of the bitstream, and up-sampling the decoded vertex depth image based on the reconstructed occupancy map coordinates.

The point cloud data reception method may be carried out by a reception device. The reception device may include a receiver configured to receive a bitstream containing point cloud data; and a decoder configured to decode the point cloud data.

Thus, the current V-PCC encoding/decoding standard supports efficient encoding/decoding of point cloud data based on video codecs. Therefore, it is not currently supported by the V-PCC standard to process mesh (triangle, polygon) information. However, in general, when point cloud data is displayed by a user's application, it is usually transformed and processed into other forms such as mesh (triangle, polygon) information to be utilized. Since the existing V-PCC standard method does not include a mesh information processor, a separate process or system is added to transmit mesh information or generate the same through post-processing depending on the application used. Therefore, in compressing 3D dynamic mesh data, if the encoding order of the connection information and the encoding order of the vertex information do not match, a mapping table should be transmitted for each vertex to match the vertex indexes of the reconstructed vertex information and the reconstructed connection information. In this case, the dynamic range of the mapping table transmitted is 0 to N (the number of vertices), and the amount of data that needs to be transmitted becomes very large and cannot be efficiently compressed.

Embodiments propose a structure in which the vertex information and connection information related to dynamic mesh data can be efficiently encoded/decoded without the need to transmit a mapping table for each vertex by compressing the depth image through a 2D encoder and encoding the occupancy map coordinates of the vertices in the encoding order of the connection information. For sparse mesh data, the depth image may be down-sampled and transmitted and the decoder may perform up-sampling based on the reconstructed occupancy map coordinates, such that position information can be efficiently encoded/decoded while maintaining the total number of vertices. This scheme has the following expected advantages.

Skipping the mapping table transmission/parsing may reduce the amount of bits to be transmitted/parsed.

By compressing the depth image with a 2D video encoder, temporal/spatial redundancy of depth information may be efficiently eliminated.

Embodiments may address the issue of transmitting a mapping table for each vertex to match the vertex indexes of the reconstructed vertex information and the reconstructed connection information when the encoding order of the connection information and the encoding order of the vertex information do not match in compressing 3D dynamic mesh data. The dynamic range of the mapping table transmitted is 0 to N (the number of vertices), which results in a large amount of data to be transmitted. If the vertex position information (x, y, z) is compressed in the encoding order of the connection information, temporal redundancy of the vertex information may not be eliminated.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

### MODE FOR DISCLOSURE

As described above, related details have been described in the best mode for carrying out the embodiments.

### INDUSTRIAL APPLICABILITY

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
encoding mesh data of the point cloud data,
wherein the encoding of the mesh data comprises:
encoding a texture map;
encoding auxiliary information;
encoding a vertex depth image;
encoding vertex occupancy map coordinates;
encoding connection information;
encoding texture coordinates; and
encoding vertex normal information,
wherein the encoding of the vertex occupancy map coordinates comprises:
encoding the vertex occupancy map coordinates based on an order of the encoding of the connection information.

3. The method of claim 1, wherein the encoding of the point cloud data comprises:
encoding mesh data of the point cloud data,
wherein the encoding of the mesh data comprises:
encoding vertex color information;
encoding auxiliary information;
encoding a vertex depth image;
encoding vertex occupancy map coordinates;
encoding connection information; and
encoding vertex normal information,
wherein the encoding of the vertex occupancy map coordinates comprises:
encoding the vertex occupancy map coordinates based on an order of the encoding of the connection information.

4. The method of claim 2, wherein the encoding of the vertex occupancy map coordinates comprises:
generating occupancy map coordinates,
sorting the occupancy map coordinates;
predicting the occupancy map coordinates; and
generating a residual based on the occupancy map coordinates and the predicted occupancy map coordinates,
wherein the generating of the occupancy map coordinates comprises:
generating an occupancy map from patches generated based on vertex position information related to the mesh data; and
generating the occupancy map coordinates based on the occupancy map,
wherein the sorting of the occupancy map coordinates comprises:
sorting the occupancy map coordinates based on the vertex position information,
wherein the sorted occupancy map coordinates are encoded in the same order as the encoding of the connection information.

5. The method of claim 2, wherein the encoding of the vertex depth image comprises:
generating a depth image from patches generated based on vertex position information related to the mesh data; and
down-sampling the depth image to one pixel.

6. A device for transmitting point cloud data, the device comprising:
an encoder configured to encode point cloud data; and
a transmitter configured to transmit a bitstream containing the point cloud data.

7. A method of receiving point cloud data, the method comprising:
receiving a bitstream containing point cloud data; and
decoding the point cloud data.

8. The method of claim 7, wherein the decoding of the point cloud data comprises:
decoding mesh data of the point cloud data,
wherein the decoding of the mesh data comprises:
decoding a texture map;
decoding auxiliary information;
decoding a vertex depth image;
decoding vertex occupancy map coordinates;
decoding connection information;
decoding texture coordinates; and
decoding vertex normal information,
wherein the decoding of the vertex occupancy map coordinates comprises:
decoding the vertex occupancy map coordinates based on an order of the decoding of the connection information.

9. The method of claim 7, wherein the decoding of the point cloud data comprises:
decoding mesh data of the point cloud data,
wherein the decoding of the mesh data comprises:
decoding vertex color information;
decoding auxiliary information;
decoding a vertex depth image;
decoding vertex occupancy map coordinates;
decoding connection information; and
decoding vertex normal information,
wherein the decoding of the vertex occupancy map coordinates comprises:
decoding the vertex occupancy map coordinates based on an order of the decoding of the connection information.

10. The method of claim 8, wherein the decoding of the vertex occupancy map coordinates comprises:
reconstructing occupancy map coordinates, comprising:
decoding the occupancy map coordinates in the bitstream;
generating a residual related to the vertex occupancy map coordinates by dequantization; and
generating a predicted value related to the vertex occupancy map; and
decoding a patch index related to the occupancy map coordinates based on an order of the reconstructing of the vertex occupancy map coordinates.

11. The method of claim 10, wherein the patch index is predicted based on a value of a previously reconstructed patch index.

12. The method of claim 10, wherein the decoding of the vertex depth image comprises:
decoding the vertex depth image in the bitstream; and
up-sampling the decoded vertex depth image based on the reconstructed occupancy map coordinates.

13. A device for receiving point cloud data, the device comprising:
a receiver configured to receive a bitstream containing point cloud data; and
a decoder configured to decode the point cloud data.

14. The device of claim 13, wherein the decoder configured to decode the point cloud data comprises:
a decoder configured to decode mesh data of the point cloud data,
wherein the decoder performs operations, the operations comprising:
decoding a texture map;
decoding auxiliary information;
decoding a vertex depth image;
decoding vertex occupancy map coordinates;
decoding connection information;
decoding texture coordinates; and
decoding vertex normal information,
wherein the decoding of the vertex occupancy map coordinates comprises:
decoding the vertex occupancy map coordinates based on an order of the decoding of the connection information.

15. The device of claim 13, wherein the decoder configured to decode the point cloud data comprises:
a decoder configured to decode mesh data of the point cloud data,
wherein the decoder configured to decode the mesh data performs operations, the operations comprising:
decoding vertex color information;
decoding auxiliary information;
decoding a vertex depth image;
decoding vertex occupancy map coordinates;
decoding connection information; and
decoding vertex normal information,
wherein the vertex occupancy map coordinates are decoded based on an order of the decoding of the connection information.
